(19) United States
(12) Patent Application Publication
(10) Pub. No.: US 2019/0130028 A1
(43) Pub. Date: May 2, 2019

(54) MACHINE-BASED EXTRACTION OF CUSTOMER OBSERVABLES FROM UNSTRUCTURED TEXT DATA AND REDUCING FALSE POSITIVES THEREIN

(71) Applicant: GM Global Technology Operations LLC, Detroit, MI (US)

(72) Inventors: Dnyanesh G. Rajpathak, Troy, MI (US); Susan H. Owen, BLOOMFIELD HILLS, MI (US); Joseph A. Donndelinger, DEARBORN, MI (US); John A. Cafeo, FARMINGTON, MI (US); Martin Case, WARREN, MI (US); Carolyn Nguyen, TROY, MI (US); Charles M. Chandler, Detroit, MI (US)

(73) Assignee: GM Global Technology Operations LLC

(21) Appl. No.: 15/794,670

(22) Filed: Oct. 26, 2017

(51) Int. Cl. G06F 17/30; G06Q 10/00; G06Q 30/00; G06Q 30/02

(52) U.S. Cl. CPC G06F 17/30707; G06Q 10/20; G06N 99/005; G06Q 30/0201; G06F 17/30684; G06Q 30/016

(57) ABSTRACT

A system having an annotation module that annotates, using a master ontology, unstructured verbatim regarding a product and related issue, and a customer-observable (CO) construction module determining associations amongst terminology in the annotated output, yielding a group of CO pairs. A CO merging module merges at least one first CO pair into a second CO pair based on similarities. A pointwise mutual-information module determines which CO pairs of the group of merged CO pairs are relatively more-severe or more-relevant, yielding a group of critical CO pairs. An output module initiates activity to implement the results, such as by automated repair of the product or change to product design or manufacturing process. The system in some embodiments identifies, using a subject-matter-expert (SME) database, features of false-positive associations, and in machine-learning implements the features to improve CO formation going forward.

### TECHNICAL FIELD

The present disclosure relates generally to machine-based extraction of relevant information from unstructured text data and, more particularly, to extracting critical customer observables from unstructured text data using a master ontology, and to reducing false positives results. The unstructured text data is received from a single source or multiple sources, such as vehicle-owner-questionnaires or service-center data.

### BACKGROUND

This section provides background information related to the present disclosure which is not necessarily prior art.

Original equipment manufacturers (OEMs) of vehicles, such as automobiles, rely on service-repair data or customer-feedback form data to learn about the product and possible ways to improve the design, and development, manufacturing, and service processes. In many cases, this is a manual process whereby personnel read the feedback or data to determine how to improve the vehicle or making process.

OEMs often also rely on data originating from several other sources. An example source is government websites on which customers can communicate product faults, such as vehicle owner's questionnaires (VOQs) via the National Highway Traffic Safety Administration (NHTSA) site. The government or product maker may also provide call centers, such as an OEM customer assistance center (CAC) or technician assistance center (TAC), to allow customers to communicate product issues. Another raw data source is a Global Asset Reporting Tool (GART).

Because the data is unstructured, and especially when it is from various sources, in various formats, it is very laborious to make good use of the data.

### SUMMARY

The present application is directed to a system and method that determines critical data, and formats it for easy further action, from service repair data and/or customer feedback data from one or more of a variety of sources.

The technology includes a natural-language processing algorithm for automatically constructing customer observable (CO) data based on unstructured data from one or more sources, such as vehicle-owner questionnaire (VOQ) data or vehicle and service-center data.

The process in various embodiments includes clustering or classifying the data, based on features in the unstructured text, in forming the CO data.

The technology in various embodiments includes a class-based language model that allows constructing customer observables by associating relevant critical multi-term phrases, e.g., parts, symptoms, accident events, body impact, etc., reported in data without using any pre-defined rule-set or language template.

The customer observables allow linking of multi-source high volume data that helps to identify emerging issues to be detected related to safety and quality.

In various embodiments, at least one pointwise mutual information (PMI) model may be used to further process the information to a more usable form.

Resulting critical COs can be used for further detecting emerging issues with the product. The clustered data provides a good indicator about criticality/severity of field issues.

In various embodiments, false positives are avoided by machine training, or machine learning. In the process, the machine is trained to avoid the false positive identified in parsing subsequent high-volume, multi-source, data, for constructing good, quality, customer observables quickly and efficiently.

Quality and consistent customer observables provide a convenient manner to identify field-emerging issues, or issues being expressed by the product in use, including to determining levels or severity of the issue. Quality and consistent customer observables thus provide a valuable insight to identify desired or needed changes to product design or use, or other factors affecting the product.

A machine-learning algorithm makes use of the identified features in the text data in various embodiments, and uses the features to classify extracted customer observables and reduce false positives—that is, reduce or eliminate instances in which the system incorrectly associates a subject report about a vehicle (from, e.g., a customer or service report) with a wrong symptom.

In various embodiments, the algorithm is used to train the system to automatically classify extracted customer observables into true positives and false positive classes using a very small amount of training data. By comparing identified features in a small training sample, efficacy of the extraction algorithm in a much larger database from which the sample was drawn can be assessed. Various tunings of the extraction algorithm can automatically be chosen based on a summary of features in any new database to be mined.

An example result is transitivity between identified secondary and primary terms as one of one or more features to improve the algorithm.

The approach is a novel manner to identify and classify customer observable features using the machine-learning algorithm.

By reducing false positives, the customer observables are even more useable and effective for automated parsing of many—e.g., millions—of unstructured text data points (i.e., unstructured verbatim), as the false positives can be easily identified early and removed or not further read or otherwise processed.

As an example, consider a customer report indicating that the customer is “tired of the horn sounding flat.” A less-sophisticated system may identify the word “flat” and automatically assume there is a tire issue, and so associate the report with a pre-established flat tire symptom. Or the system may reach the same inaccurate result after noticing the word, “flat” and the word, “tired,” being similar to “tire.” Such associations are examples of a false positive association or determination.

One aspect of the present technology includes a system having a hardware-based processing unit and a non-transitory computer-readable storage device. The storage device includes an annotation module that, when executed by the hardware-based processing unit, obtains unstructured verbatim describing a subject product and one or more issues for the product, and annotates the unstructured verbatim, using a master ontology, yielding annotated output.

The system also includes a customer-observable construction module that, when executed by the hardware-based processing unit, determines associations amongst terminology in the annotated output, yielding a group of customer-observable pairs.

In various implementations, the system further includes a customer-observable merging module that, when executed by the hardware-based processing unit, merges at least one first customer-observable pair of the group of customer-observable pairs into at least one second customer-observable pair of the group of customer-observable pairs, or removes the at least one first customer-observable pair, based on similarity between the at least one first and second customer-observable pairs, yielding a group of merged customer-observable pairs.

The system may also include a pointwise mutual-information module that, when executed by the hardware-based processing unit: determines which customer-observable pairs of the group of merged customer-observable pairs are relatively more-severe or more-relevant, yielding a group of critical customer-observable pairs.

And the system may include an output module that, when executed by the hardware-based processing unit: analyzes the critical customer-observable pairs and implements remediating or mitigating activities based on results of the analysis; or sends the group of critical customer-observable pairs to a destination for analysis and implementation of remediating or mitigating activities.

Further regarding the annotation module, in various implementations it may include a preprocessing sub-module that, when executed removes from the unstructured verbatim unwanted characters, spaces, and/or terms; lemmatizes terms; and/or stems terms.

Further regarding the annotation module, in various implementations it may include a preprocessing sub-module that pre-processes at least a portion of the unstructured verbatim in a manner based on an identify or characteristic of a raw-data source from which the portion of the unstructured verbatim was received.

Further regarding the annotation module, in various implementations it may include an annotation engine that, when executed, in using the ontology, uses an ontology tree or mapping structure.

The tree or mapping structure in various implementations associates each of numerous common terms or phrases related to the product with one or more classes; and the classes include any of the following: defective part; symptom; failure mode; action taken; accident event; body impact; body anatomy.

In various implementations, the annotation module includes an annotation engine that, when executed, uses the ontology and test-structure parsing data to annotate the unstructured verbatim, whether the unstructured verbatim is otherwise earlier processed by the annotation module.

Each customer observable formed includes a primary term, and a secondary term, and the customer-observable-construction module may include an indices sub-module that, when executed, determines a proximity between the first and secondary terms/phrases along with identified features.

The annotation module may include a verbatim splitter sub-module that, when executed, divides the unstructured verbatim into multiple parts. In this case, with each part being a sentence or phrase; the customer-observable-construction module, when executed, in some embodiments scans the sentences or phrases to identify key terms or phrases for determining customer observables; and for the scanning the customer-observable-construction module includes a forward-pass sub-module that, when executed, scans each sentence or phrase in a forward direction; and a backward-pass sub-module that, when executed, scans each sentence or phrase in an opposite direction.

In some embodiments, the customer-observable-construction module, when executed, clusters customer observables based on proximity between a primary term and a secondary term in each of the customer observables.

Regarding false-positive identification and implementation by machine learning, in some embodiments, a database-comparison module that, when executed by the hardware-based processing unit: obtains, from a subject-matter-expert (SME) database, SME information about the unstructured verbatim; compares, in a comparison, the group of critical customer observables to the SME information; and identifies, based on results of the comparison, false-positive relationships amongst the customer observables of the group of critical customer observables. A feature-identification module, when executed, determines false-positive-indicia features related to the false-positive relationships.

The output module, when executed by the hardware-based processing unit, provides the false-positive-indicia features to a machine-learning module for incorporation of the features into system code for use in subsequently generating critical customer observables better.

The database-comparison module, in contemplated embodiments, identifies, based on results of the comparison, true-positive relationships amongst the customer observables of the group of critical customer observables, and the feature-identification module that, when executed, determines true-positive-indicia features related to the true-positive relationships.

The technology is not limited to the above example embodiments.

The technology in various implementations includes the storage device described above and processed performed by the system described.

Other aspects of the present technology will be in part apparent and in part pointed out hereinafter.

### DESCRIPTION OF THE DRAWINGS

FIG. 1 is a computing environment, showing representative operation modules, for embodiments of the present technology.

FIG. 2 shows first annotation sub-modules of the environment of FIG. 1.

FIG. 3 shows second annotation sub-modules of the environment of FIG. 1.

FIG. 4 shows first customer-observable-formation sub-modules of the environment of FIG. 1.

FIG. 5 shows second customer-observable-formation sub-modules of the environment of FIG. 1.

FIG. 6 illustrates schematically aspects of transitivity operations performed by the feature-identification modules to reduce false positives in identifying reliable, critical, customer observables.

FIGS. 7-25 illustrate various structure, processes, data, and results supporting and yielded by the present technology.

The features and advantages of the present invention will become better understood from a careful reading of a detailed description provided herein below with appropriate reference to the accompanying drawings.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

The present technology allows an entity, such as a product manufacturer, to learn about performance of a product in the field from a novel automated system that intelligently analyzes field data, such as reports from governmental agencies or product service centers. Issues identified can stem from a design, or design or manufacturing process, that can be improved.

In various embodiments, findings are vetted to identify false positive results. The system by machine learning considers the results to improve subsequent identification of critical customer observables from the unstructured source data. In some embodiments, the system is configured to identify false positive results on only a small, or at least partial, sample of a larger sample, and perform the learning for improving system operation on the entire or balance of the sample, as well as on future unstructured text data.

I. Customer Observable Extraction Structure and Functions

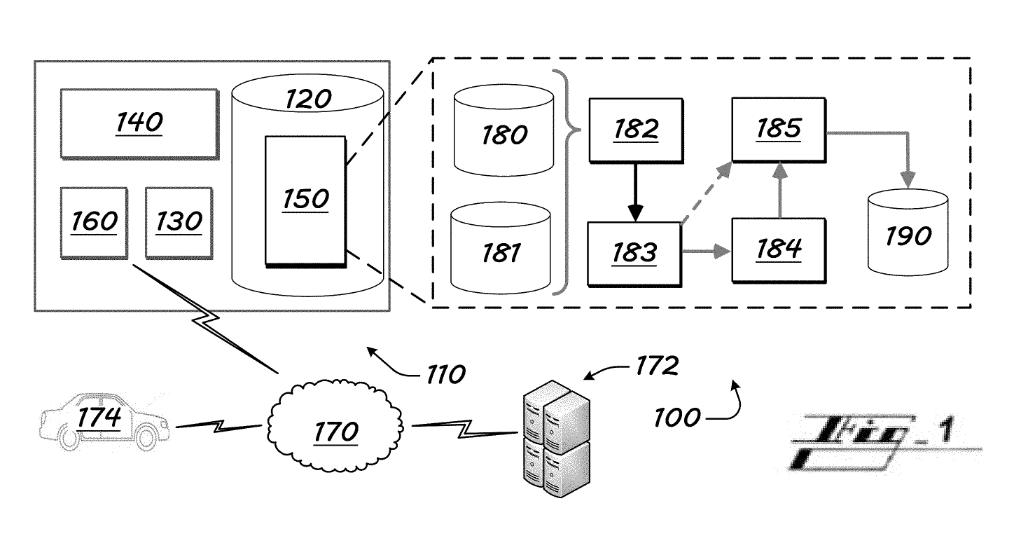

FIG. 1 is a computing environment 100, showing representative operation modules, for embodiments of the present technology used to generate relevant, reliable, critical customer-observable (CO) data.

The CO data can be used by personnel, computers or automated machinery in various ways, such as to repair a vehicle, communicate an instruction, such as to product designers on how to improve a product design, or improve a product-making process, or to product dealers (e.g., auto dealerships), indicating a manner for repairing the product, as a few examples.

For various embodiments of the present technology, a customer observable can be viewed generally as a tuple of relevant two-part critical multi-term phrases, which can be represented as (Primaryᵢ, Secondaryⱼ), where there are “i” number of primary terms (or phrases, being more than one word) identified in a sample of unstructured text, and “j”, the number of secondary terms or phrases. Example terms include product parts (e.g., switch), symptoms (e.g., faulty), events, and context (e.g., “side swipe”), to name a few. The primary term is often a part of the product, such as “steering wheel” (as ‘steering wheel’ in “steering wheel not able to be turned), but a part can be secondary, or not primary or secondary (as ‘steering wheel’ in “radio malfunctioned without me even touching it—I had both hands on the steering wheel at the time”).

Some of the terms of the unstructured input text are identified as primary terms, and some as corresponding secondary terms. This identification is in various embodiments performed based on associations between the terms, or forms of the term, and primary or secondary indicators, in a guiding structure, such as an ontology database, described further below.

Example combinations:
(Partᵢ< > Symptomⱼ)
   Airbags< >Did Not Deploy, Steering< >Locked, Ignition Switch< >Faulty
(Symptomi < > Symptomⱼ)
   Hard Start< >P0100, Black Smoke< >Stalling, Misfire< >Whining Noise
(Symptomᵢ< > Accident Eventⱼ)
   Stalling< >Crash, Unable To Steer< >Rollover
(Accident Eventᵢ < > Body Impactⱼ)
   Crash< >Abrasion, Head On Collision< >Concussion
(Body Impactᵢ < > Body Anatomyⱼ)
   Abrasion< >Arms, Concussion< >Neck

The environment 100 includes a hardware-based computing or controller system 110 of FIG. 1. The controller system 110 can be referred to by other terms, such as computing apparatus, controller, controller apparatus, or such descriptive term, and can be or include one or more microcontrollers, as referenced above.

The controller system 110 is in various embodiments part of the mentioned greater system, such as a server arrangement.

The controller system 110 includes a hardware-based computer-readable storage medium, or data storage device 120 and a hardware-based processing unit 130. The processing unit 130 is connected or connectable to the computer-readable storage device 120 by way of a communication link 140, such as a computer bus or wireless components.

The processing unit 130 can be referenced by other names, such as processor, processing hardware unit, the like, or other.

The processing unit 130 can include or be multiple processors, which could include distributed processors or parallel processors in a single machine or multiple machines. The processing unit 130 can be used in supporting a virtual processing environment.

The processing unit 130 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 120 is any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The data storage device 120 includes one or more storage modules 150 storing computer-readable code or instructions executable by the processing unit 130 to perform the functions of the controller system 110 described herein.

The data storage device 120 in some embodiments also includes ancillary or supporting components, such as additional software and/or data supporting performance of the processes of the present disclosure, such as one or more user profiles or a group of default and/or user-set preferences.

As provided, the controller system 110 also includes a communication sub-system 160 for communicating with local and external devices and networks 170, 172, 174.

The communication sub-system 160 in various embodiments includes any of a wire-based input/output (i/o), at least one long-range wireless transceiver, and one or more short- and/or medium-range wireless transceivers.

By short-, medium-, and/or long-range wireless communications, the controller system 110 can, by operation of the processor 130, send and receive information, such as in the form of messages or packetized data, to and from the communication network(s) 170.

The remote devices 172, 174 can be configured with any suitable structure for performing the operations described herein. Example structure includes any or all structures like those described in connection with the controller system 110. A remote device 172, 174 includes, for instance, a processing unit, a storage medium comprising modules, a communication bus, and an input/output communication structure. These features are considered shown for the remote device 172, 174 by FIG. 1 and the cross-reference provided by this paragraph.

Example remote systems or devices 172, 174 include a remote server 172 (for example, application server), and a remote data, customer-service, and/or control center. The controller system 110 communicates with remote systems via any one or combination of a wide variety of communication infrastructure 170, such as the Internet, cellular systems, satellite systems, etc.

An example remote system 172 is an OnStar® control center, having facilities for interacting with vehicle-performance-related data sources, such as vehicle service centers, a governmental vehicle-owners-questionnaire (VOQ) source, vehicles, and users or user products 174, such as vehicles. ONSTAR is a registered trademark of the OnStar Corporation, which is a subsidiary of the General Motors Company.

At the right of FIG. 1, the example storage modules 150 of the data storage device 120 are shown.

Any of the code or instructions of the modules 150 described can be part of more than one module. And any functions described herein can be performed by execution of instructions in one or more modules, though the functions may be described primarily in connection with one module by way of main example. Each of the modules can be referred to by any of a variety of names, such as by a term or phrase indicative of its function. Use of the word, ‘term,’ herein can refer to any part of the verbatim, including a word, multiple adjoining words, a phrase, a symbol or symbols, the like, other, or any combination of such.

Sub-modules can cause the processing hardware-based unit 130 to perform specific operations or routines of module functions. Each sub-module can also be referred to by any of a variety of names, such as by a term indicative of its function.

Example modules 150 include:
a master-ontology module 180 or database;
an unstructured product-data source module 181 or database;
a phrase-annotation module 182;
a customer-observable-construction module 183;
a customer-observables-merging module 184;
a point-wise-mutual-information module 185; and
an extracted-customer-observables module 190 or database.

I.A. Master-Ontology Module 180

A master-ontology module 180 or database stores or obtains data related to a subject product, such as a vehicle, that has been structured or ordered based on one or more relationships. The data may be structured, for instance, by classifying according to vehicle parts, vehicle part sub-classes, and relationships amongst relevant factors for the parts or sub-classes, such as symptom relationships and action relationships.

For implementations in which the ontology relates to safety issues, the ontology may be referred to as a safety ontology, or master safety ontology, and include structured safety-focused data, related to the parts of the product and how they can be or become less safe, or context (e.g., situations, like a side swipe or impact) that can compromise or damage the product.

Data in the ontology may associate products parts, such as a tire, with product symptoms or malfunctioning conditions, such as being flat in the case of the tire.

In various embodiments, the ontology, or each of a group of ontologies, has a set of rules and a class structure having a plurality of data classes. Data classes that are the same or consistent can be merged into a new data class, or into an existing data classes. Redundant or otherwise leftover data classes can be discarded.

A resulting ontology in various embodiments includes automatic mapping of the classes.

The ontology in some implementations is uniform, having one structure or taxonomy to apply to any type of verbatim, or verbatim from any source, as opposed to having various taxonomies for various situations (sources, formats of verbatim). The taxonomy may include, for instance, data indicating parts or components, and common, expected, or possible symptoms and events that may affect the parts.

The ontology in various embodiments describes rules for processing raw data collected from different sources, and rules for associating the processed collected data with data classes.

The ontology module or database may include a single ontology or multiple ontologies, and any one or more of the ontologies may be formed by merging multiple ontologies. In merging, for instance, various ontologies, from or corresponding to, various sources—e.g., organizations, having respective class structures—are compared to determine similarities and/or differences. If the ontologies are different from each other, it is checked whether they are consistent with each other. That is, the classes from the different ontologies are compared with each other to see whether they are consistent with each other. Also in various embodiments, instances of classes are compared with each other to make sure that there is no conflict with class affiliations. For example, the instance “does not work” in one ontology may be represented as an instance of the class SY while in other ontology it is represented as an instance of the class FM.

The inconsistent rules as well as inconsistent classes and instances are in some implementations resolved by merging the classes into a single consistent class and their instances are merged accordingly, while the rules and the classes that are not relevant to the application are removed from the resulting ontologies. The consistent rules are merged with identical rules from the different ontologies along with metadata collected from new sources. The new data includes metadata and also new ontologies. The rules from different ontologies are merged, and a new set of the ontology is created, with a new data class structure.

The metadata is used to map the vocabulary used to capture the phrases in external source data to an internal data that has a common understanding across different organizations. For example, if service data consists of the phrase ‘engine control module,’ whereas the internal metadata has the phrase ‘powertrain control module,’ which may be understood by a relevant engineering, or manufacturing, group, etc., then the term ‘engine control module’ referred in the external data is mapped to the internal database automatically. In this way, when a modification to the design requirements is required, the design or engineering teams can know precisely what type of faults/failures were observed and mentioned in the external data, and these fault/failures are associated with which part/component. By learning the failure and the component associate with the failure, the design and engineering team can make necessary changes to overcome the problem and to avoid the similar fault in future.

Example ontologies are also described in prior patents and patent applications from the same assignee, including U.S. Pat. Nos. 8,176,048 and 8,010,567, U.S. Publ. Pat. Appl. Nos. 2012/0011073 and 2010/0250522.

I.B. Unstructured Product-Data Source Module 181

An unstructured product-data source module 181 or database includes product-performance data from one or more of any of a variety of sources. The data can be formatted before or after receipt or generation in any suitable format, such as in an Excel file.

Example sources for the automotive industry include sources external to the OEM, such as externally collected vehicle owners questionnaire (VOQ) data, NHTSA, and others, and sources typically internal to the OEM, such as warranty records, technician assistance center (TAC) data, customer assistance center (CAC) data, internal captured test fleet (CTF) data, Emerging Issue (EI) log data, Global Vehicle Safety (GVS) core data, and others.

Typically, data from these sources consist of unstructured text, or verbatim data, and may be referred to as raw data. The data is referred to as unstructured, verbatim, or raw because it is typically not arranged in a particular manner, or only arranged in a limited manner.

The unstructured text data may be represented by records created from feedback provided by different customers, different technicians at dealerships, or different subject matter experts, at a technician assistance center, for instance. Because there are typically not pat responses or standardized vocabulary used to describe the problem, several verbatim variations are observed for mentioning the same problem. An auto maker must extract the necessary fault signal out of all such data points to perform safety or warranty analysis, so the design of the system can be improved to save future vehicle fleet from facing the same problem.

For instance, a customer calling a government helpline, or OEM call center, will describe a product issue in any way, and multiple persons would describe the situation differently. For instance, while one person may say that “the engine is clanking,” another may say, “there is noise from the engine,” while another may say, “I hear something coming from under the hood”—all in response to the very same issue.

Regarding the potential for the data to be partially structure, it is contemplated that a person providing the data may have been given some instructions on an order by which to provide the information. A service technician may be trained for instance to first mention a subject product part (e.g., steering gear), and then mention the issue, so that all or most data from that source should not reference the issue first. However, ordering may still vary despite such instructions to personnel. And, regarding other data sources, e.g., VOQ, the ordering is much more likely to vary, such as in some cases the part being mentioned before the issue (e.g., part fault or failure), while in other cases, the issue is mentioned before the part, though regarding the same situation, or same type of situation. In some cases, there is more than one relevant part and/or more than on relevant issue, and order of recitation can take any of the various orders possible. In all such cases, the data can still be considered as raw for various reasons, such as the data being loosely formatted still does not with focus indicate only a subject part and a symptom, and the data still including unneeded articles or connecting words (e.g., “a,” “an,” “the”).

Complaint or repair verbatim describes the problems faced by the vehicle owners. Complaint or the repair verbatim consists of information including any of: data indicating directly or indirectly a faulty part/system/subsystem/module/wiring connection, data indicating related symptoms observed in the fault situation, data indicating failure modes identified as causing the parts to fail, and/or data indicating repair actions needed, recommended, or performed to fix the problem.

The unstructured text data may include context data such as data related to a subject accident event (e.g., an accident causing the product issue, or caused by the issue), how a vehicle body was impacted, and vehicle body anatomy that was affected in the accident event.

The unstructured text often includes special characters such as ‘?’, ‘, ’, ‘!’, ‘%’, ‘&’, and so on. Typically, these special characters do not add any value to the text analytics and therefore by deleting them, according to processing of the present technology, unnecessary information is removed in honing the verbatim to the essential parts, including the customer observables.

In a contemplated embodiment, the context data includes information indicting the type of product, such as automobile, that the verbatim is about. Context data may indicate for instance, that a subject vehicle is a 2015 Chevrolet Tahoe.

While in some embodiments, at least some context data is received with, not derived from the verbatim, in others embodiments, at least some context data is derived from the verbatim, such as a service person mentioning that the subject vehicle is a MY15 Tahoe.

I.C. Phrase-Annotation Module 182

A phrase-annotation module 182 applies the ontology 180 to the unstructured text, or raw, data from the unstructured product-data source module 181, along with any context data included with or separate from the unstructured text data.

As provided, the ontology in various embodiments includes automatic mapping of the classes, and describes rules for processing raw data collected from different sources, and rules for associating the processed collected data with data classes.

And, as mentioned, the data comes from different sources and different stakeholders provide information associated with the faulty parts, their symptoms, the failure modes, etc. In various embodiments, it is important that the information extracted and organized from these different data sources into an ontology is mapped consistently with pre-existing internal data to provide better understanding of where the problem resides in the vehicle system, sub system, modules, etc.

When a safety organization applies the proposed processes to analyze the safety-organization data, such as NHTSA VOQ data classes, such as part, symptom, body impact, body anatomy and actions, which are relevant for the service-and-quality organization, can be omitted, and new classes such as accident events, body impact, and body anatomy are automatically learned from the data. The new classes are learned from the data as the new information becomes available and when the existing class structure provide limited mapping to organize the information in the data.

Text mining algorithms are commonly used to extract fault information from the unstructured text data. The text mining algorithms apply the ontologies to first identify the critical terms such as faulty parts/systems/subsystems/modules, the symptoms observed in a fault situation, the failure modes, the repair actions, accident events, body impact, and body anatomy mentioned in the unstructured text data. One of these text mining methods is described in the U.S. Published Patent Application No. 2012/0011073, which is incorporated here in its entirety by this reference.

The ontologies associated with different data sources are extracted, but because there are variations in the way the terms are mentioned in different data from various sources, as well as not all data sources necessarily mentioning all critical terms to describe the situation, it is important to process the extracted ontologies. Extracted multi-term phrases from different data sources are mapped to the existing class structure that precisely captures the types of information recorded in a specific data source. In various embodiments, the existing class structure includes any one or more of the following classes:
S1 (defective part),
SY (Symptom),
FM (failure mode),
A (Action taken),
HW (Hazard Words),
AE (Accident Event),
BI (Body Impact), and
BA (Body Anatomy).

These classes are also used by different organizations to organize the instances of these classes when extracted from the data. Each organization may form different class structures based on the data that the organization is analyzing to derive business insight and, because each of the organizations has different focuses, the corresponding classes in various embodiments reflect the focus or focuses of each respective organization.

For each manufacturer, the appropriate class structures for the data in hand are identified as per organization requirements, and the class structures are modified accordingly. For example, a service-and-quality organization may be interested in identifying the faulty parts/systems/subsystems/modules, the symptoms observed in a fault situation, their associated failure modes, and the repair actions, while a safety organization may be interested in faulty parts/systems/subsystems/modules, the symptoms observed in a fault situation, along with accident events, body impact if any, and the body anatomy affected in the accident event.

The service-and-quality organization can apply the processes of the present technology on the data to enable the class instances to be automatically mapped to the appropriate classes relevant to the organization.

Because the raw data may be from difference sources, a similar product issue may be described differently. An unstructured description of, “Customer states engine would not crank. Found dead battery. Replace battery,” for instance, may be expressed differently, such as, “customer said engine does not start; battery bad and replaced.” After applying the same ontology, “engine does not start” may be associated consistently with the symptom, which is class SY, and “battery bad” may be consistently associated with the incident as the failure mode, which is class FM, even though the such phrases are coming from different verbatim. The application of the same ontology allows the class structures to be identical. In other instances, the phase “internal short” in some verbatim may be referred to as the symptom while in some other verbatim it is referred to as the failure mode.

The determination on when a phase is interpreted as one class (e.g., symptom) or another class (e.g., failure mode) can be done through a probability model. The internal probability model estimates the likelihood of a phrase, say “internal short,” being reported as a symptom versus it being reported as a failure mode in the context of the data. That is P(Internal Short_{SY}|Co-Occurring Termᵢ) and P(Internal Short_{FM}|Co-Occurring Termᵢ), where Co-Occurring Termᵢ represent the terms, which are co-occurring with the phrase “Internal Short” in verbatim and based on a higher probability value that such phrase is assigned either to the class SY or to the class FM. The P(Internal Short_{SY}|Co-Occurring Termᵢ) is in various embodiments calculated as follows.

$$P ( Internal {Short}_{SY} \vert Co \text{-} occurring {Term}_{j} ) = arg {max}_{Internal {Short}_{SY}} \frac{\begin{matrix}P ( Co \text{-} occurring {Term}_{j} \vert Internal {Short}_{SY} ) \\ P ( Internal {Short}_{SY} )\end{matrix}}{P ( Co \text{-} occurring {Term}_{j} )} \qquad [ Eqn . 1 ]$$

Because the same set of terms co-occur with Internal Short_{Sy}, the denominator from Eq. (1) can be removed, yielding Eq. (2):

P(Internal Short_{SY}|Co-occurring Termⱼ)=argmax_{Internal Short}_{_{SY}}(P(Co-occurring Termⱼ|Internal Short_{SY})P(Internal Short_{SY})) [Eqn. 2]

All the co-occurring terms with the phrase “Internal Short” make up our context ‘C,’ which is used for the probability calculations. And using a suitable assumption, such as the Naïve Bayes assumption, that each term co-occurring with the phrase “Internal Short” is independent, yields Eq. (3):

$$P ( C \vert Internal {Short}_{SY} ) = P = ( \{ Co \text{-} occurring {Term}_{j} \vert Co \text{-} occurring {Term}_{j} in C \} \vert Internal {Short}_{SY} ) = {\prod }_{Co \text{-} Occurring {Term}_{j} ∈ C}^{ } P ( Internal {Short}_{SY} \vert Co \text{-} occurring {Term}_{j} ) \qquad [ Eqn . 3 ]$$

The probabilities, P(Co-occurring Termⱼ|Internal Short_{SY}) and P(Internal Short_{SY}) in Eq. (2) is calculated using Eq. (4):

$$P ( Co \text{-} occurring {Term}_{j} \vert Internal {Short}_{SY} ) = \frac{f ( Co \text{-} occurring {Term}_{j} , Internal {Short}_{SY} )}{{f}_{Internal {Short}_{SY}}} \\ and \\ P ( Internal {Short}_{SY} ) = \frac{f ( Internal {Short}_{SY} )}{f ( {Term}^{′} )} \qquad [ Eqn . 4 ]$$

On the same lines, now we show how we calculate the P(Internal Short_{FM}|-occurring Termⱼ) below.

$$P ( Internal {Short}_{FM} \vert Co \text{-} occurring {Term}_{i} ) = arg {max}_{Internal {Short}_{FM }} \frac{\begin{matrix}P ( Co \text{-} occurring {Term}_{i} \vert Internal {Short}_{FM} ) \\ P ( Internal {Short}_{FM} )\end{matrix}}{P ( Co \text{-} occurring {Term}_{i} )} \qquad [ Eqn . 5 ]$$

Because there are same set of terms co-occur with Internal Short_{FM}, the denominator may be removed from Eq. (5), yielding Eq. (6):

P(Internal Short_{FM}|Co-occurring Termᵢ)=argmax_{Internal Short}_{_{FM}}(P(Co−occurring Termᵢ|Internal Short_{FM})P(Internal Short_{FM})) [Eqn. 6]

The co-occurring terms having the phrase “Internal Short” make up the context, ‘C’, and, using a suitable assumption such as the Naïve Bayes assumption, that each term co-occurring with the phrase “Internal Short” is independent, yields Eq. (7):

P(C|Internal Short_{FM})=P=({Co-occurring Termᵢ|Co-occurring Termᵢ in C}|Internal Short_{FM})=Π_{Co-Occurring Term}_{ᵢ}_{∈C}P(Internal Short_{FM}|Co-occurring Termᵢ) [Eqn. 7]

The probabilities, P(Co-occurring Termᵢ|Internal Short_{FM}) and P(Internal Short_{FM}) in Eq. (6) is calculated by using Eq. (8).

$$P ( Co \text{-} occurring {Term}_{i} \vert Internal {Short}_{FM} ) = \frac{f ( Co \text{-} occurring {Term}_{i} , Internal {Short}_{FM} )}{{f}_{Internal {Short}_{FM}}} \\ and \\ P ( Internal {Short}_{FM} ) = \frac{f ( Internal {Short}_{FM} )}{f ( {Term}^{′} )} \qquad [ Eqn . 8 ]$$

The probabilities P(Internal Short_{SY}|Co-Occurring Termᵢ) and P(Internal Short_{FM}|Co-Occurring Termᵢ) are compared, and if the probability P(Internal Short_{SY}|Co-Occurring Termᵢ) is higher than the probability P(Internal Short_{FM}|Co-Occurring Termᵢ), then the phrase ‘Internal Short’ is assigned to the class SY; else it is assigned to the class FM.

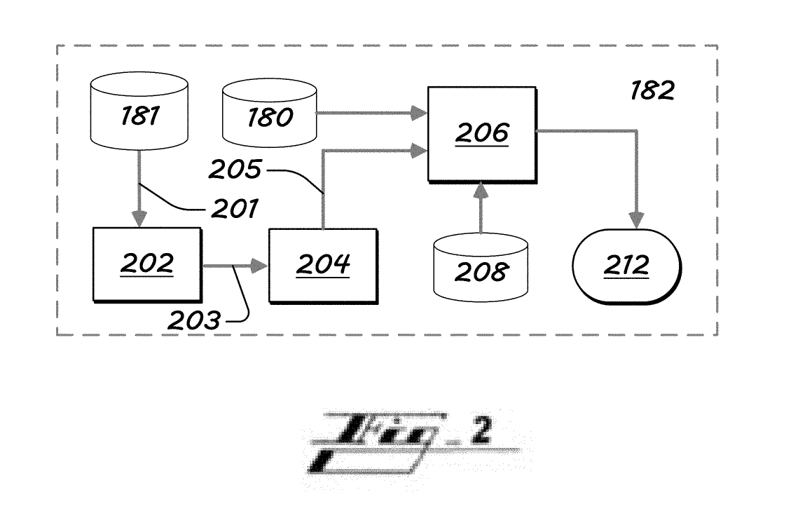

Turning to the next figure, FIG. 2 illustrates sub-modules of the phrase-annotation module 182.

A verbatim-splitter sub-module 202 receives the verbatim data from the verbatim sources, such as an unstructured product-data source module 181 or database.

As an example, the verbatim may include the following, with TR* and *TR representing start and end of transmission or text verbatim:
TR *THE CONTACT STATE BRAKE LINE FAILURE DUE TO CORROSION. VEHICLE COULD NOT BE STOPPED. AFTER 0.8 HRS OF INSPECTION ALL BRAKE LINES ARE BADLY RUSTED. *TR

The verbatim-splitter sub-module 202 may act as an initial boundary activity, and in various embodiments the splitting involves splitting the raw verbatim into parts, such as sentences.

In the above example, the verbatim 201 can be divided into three parts 203 by the verbatim splitter 202:
THE CONTACT STATE BRAKE LINE FAILURE DUE TO CORROSION.
VEHICLE COULD NOT BE STOPPED.
AFTER 0.8 HRS OF INSPECTION ALL BRAKE LINES ARE BADLY RUSTED.

The split verbatim is then passed to a data-preprocessing sub-module 204. In various embodiments, the preprocessing includes removing common unwanted characters and/or words. Example characters include symbols, such as: --.,<\\=@!“/37 #/&%>#+?( ):;_-]+\\s*.

An example code structure for the preprocessing is as follows:

```
START
Get Data (Excel file/DB query) -> VOQ data Bin
      Pre-process the data (VOQ Data) -> pre-processed data in bin
            a. “[--.<\\=@!‘‘/‘‘#/&%>#+?:;_-]+\\s*“, ” “
            b. leading/trailing and additional white spaces
            c. if required lemmatize (not sure at this point)
      Bin (ID, Index, Original verba, Pre-processed verb)
Get Ontology (DB query) -> Treemap <String, String> of S1, Sy, BI, BA,
AE
            a. Execute query (select statement)
            b. Write Comparator for Treemap to sort on longest length
to shortest length, e.g. Power steering, steering and verb “Power steering
is sloppy, steering bad”
            c. Put in respective Treemap<String, String>
Annotate Crit ical Terms (Vector<VOQ data Bin>, Treemap <String,
String> ontTerms) -> verbTermBin
      Get, eachVerb from Vector<VOQ data Bin>-> each
Verb;.toUpperCase
      Iterate (Ma1p<String, String> eachOnTer : ontTerms) ->
            Get(termName.toUpperCase) & Get(termBase
word.to.upperCase)
Pattern:: Pattern.compile(Pattern.quote(eachTermK.toUpperCase( )))
Matcher:: p.matcher(verbatimBuf.toString( ).toUpperCase( ).trim( ))
      While(matcher.find( ) ){
            int stIndex = matcher.start( ) − tempDellength
            int en Index = matcher.end( ) − tempDellength
      String replace = ‘”’;
            if ((endIndx < verbatimBuf.toString( ).length( )) &&
(startIndx >= 1) && (end Indx >= 0)) {
            Condit ion 1: if term appears at the end
            if (endIndx == verbatimBuf.toString( ).trim( ).length( )){
                  if ((verbatimBuf.toString( ).charAt(startIndx −
                  1) == ‘ ’)) {
                  Set verbatim, matched term, start index, end index
to verbTermBin
                  }
            }
            Condition 2: if term appears in middle
                  else if (startIndx >= 1) {
                        if
(((verbatimBuf.toString( ).charAt(endIndx) == ‘
’)) && ((verbatimBuf.toString( ).charAt (start Indx − 1) ==
‘ ’))) {
                  Set verbatim, matched term, start index, end index
to verbTermBin
                  }
            }
            Condition 3: if term appears at start
                  else if (startIndx == 0) {
                        if ((verbatimBuf.toString( ).trim( ).charAt
(endIndx) == ”)) {
                        Set verbatim, matched term, start index, end
index to verbTermBin
                  }}} END
```

The preprocessing in various embodiments removes unneeded spaces, and any unwanted or unneeded tags, such as a tag indicating a subject service repair shop, a time of day, or perhaps date, if these are not helpful context. The preprocessing may also include lemmatizing or stemming of terms in the verbatim.

In various embodiments, the preprocessing is automatically customized based on the particular unstructured product-data source module 181 or database. For instance, the preprocessing sub-module 204 may receive, with the verbatim, data indicating a type or identity of the source 181, such as any VOQ, or a particular VOQ. Or the preprocessing sub-module 204 determines otherwise that the source 181 has a certain type or identify, such as by a channel or manner that the verbatim is received. The preprocessing sub-module 204 may pre-process at least a portion of the unstructured verbatim in a manner based on an identity or characteristic of a raw-data source providing the portion of verbatim, for instance.

Customized preprocessing can be implemented by, for instance, the preprocessing module 204 having source-specific information advising the module 204 on what types of symbols or wording are commonly in the verbatim that should be removed, the types of wording or symbols indicating certain aspects of the verbatim. The source-specific information may indicate for instance, that “TR*” if kept in the verbatim after the splitting, or if the splitter was not used, indicates start of the verbatim. Or the source may be a repair shop, technicians there are instructed to precede identification of the subject problem part with the word “part” or “component,” and preceded indication of the symptom with the word “issue,” “problem,” or “symptom.” Such indications can be helpful in properly translating the raw verbatim toward data formatted as a customer observable/s.

By preprocessing, the above three sentences may be simplified. The preprocessed sentences or parts 205 may be simplified as follows,
BRAKE LINE FAILURE DUE TO CORROSION
VEHICLE COULD NOT BE STOPPED
0.8 HRS INSPECTION ALL BRAKE LINES BADLY RUSTED

are provided to an annotation module 206, which may be referred to as an annotation engine or annotation engine module.

In various embodiments, the annotation engine 206 operates on three inputs, annotating (i) the preprocessed sentences 205 using (ii) the master safety ontology 180 and (iii) text-structure-parsing data 209, from a text-structure parsing file or source 208.

Use of the master safety ontology 180 in various embodiments includes use of a tree or mapping structure, or a treemap, of the ontology. The functions may include performing comparative functions (using a comparator of the ontology 180). The tree or map may for instance, relate product components (e.g., vehicle parts) to respective terms or phrases describing common issues with the component.

The text-structure-parsing data 209 indicates and/or is used to determine information indicative of any suitable conditions helpful for annotating the preprocessed sentences 205. The text-structure parsing file or source 208 in various embodiments stores the text-structure parsing data 209 and/or obtains the data 209 from a source external to the system 110.

The conditions in various embodiments relate to a positioning of a phrase in the sentence, such as whether the phrase appears at a beginning, middle, or end of a sentence, and a condition can indicate whether a phrase is a part/component or a symptom/issue/problem, i.e.:
Cond 1. Phrase appears at the beginning of a sentence
Cond 2. Phrase appears in the middle of a sentence
Cond 3. Phrase appears at the end of a sentence
Cond 4. Phrase is part and symptom

In some embodiments, respective phrases falling under each condition are marked or ‘matched,’ e.g.:
Cond 1=>match term appearing at beginning: ‘‘End Index+’’;
Cond 2=>match term appearing in middle: ‘‘+Start Index, End Index+’’;
Cond 3=>match term if it appears at end: ‘‘+Start Index’’.

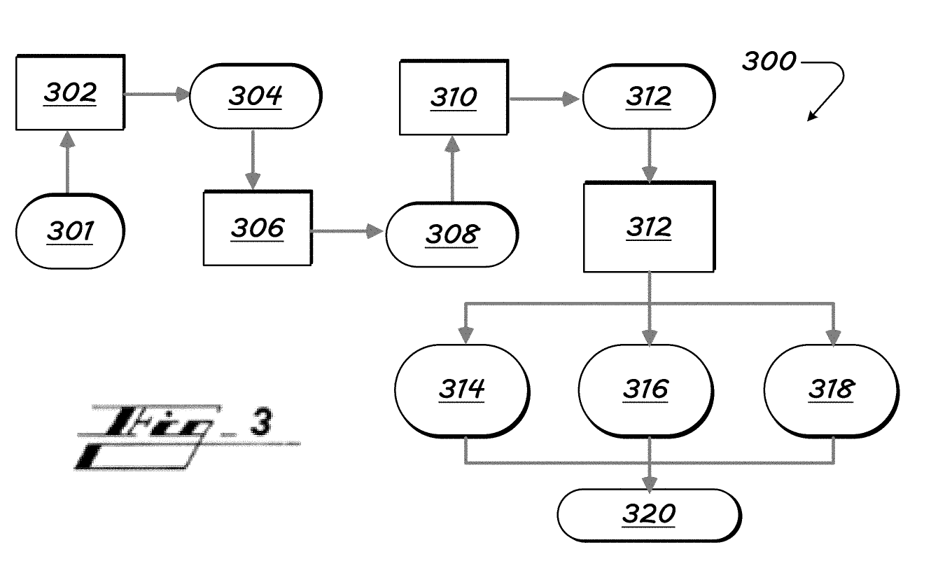

In various embodiments, the annotation is performed by a critical phrase matcher engine. FIG. 3 shows an arrangement 300 including the critical phrase matcher engine or sub-module 312 (CPME). At 301, primary input including ‘String eachVoqVerb’ is processed at a sentence boundary detection engine or sub-module 302 (SBDE). The SBDE 302 splits the sentences, which are set: ‘set splitSentences (Sen1, . . . , Seni) 304 [i=number of sentences]. At block 306, the split sentences are reorganized, which are set: ‘Set reorgSentences (Sen1, . . . , Seni).

At block 308, the reorg sentences of the verbatim are processed to identify verbs, yielding a ‘StringBuffer verbBuf’ 310.

The CPME 312 processes the processed verbatim according to the mentioned various conditions—e.g., conditions 1 to 3, or 1 to 4. Example resulting coding for conditions 1-3:
Condition 1: Term appears in the beginning
If Term_{end index}<verbBuf length &&
Term_{start index}>=0&&
verbatimBuf.charAt(Term_{start index}+1)= =’ ’
Then
matchedTerms(Termᵢ)
Condition 2: Term appears in the middle
If verbatimBuf.charAt(Term_{end index}+1)= =’ ’ &&
verbatimBuf.charAt(Term_{start index}−1)= =’ ’) Then
matchedTerms(Termᵢ)
Condition 3: Term appears in the end
If verbatimBuf.charAt(Term_{start index}−1)==” &&
verbatimBuf.toString( ).charAt(Term_{end index}= =verbBuf length
Then
matchedTerms(Termᵢ)

A resulting annotated term map 320 can be represented as follows:
eachVerb, eachSente,
eachMatchedTerm,
theStartIndex, theEndIndex,
theMatchedTermType

Any of the annotating described above, collectively under the phrase-annotation engine or module 182, highlights or calls out one or more levels important terms or words in the sentences or phrases formed. Using the example three sentences above, annotations are shown here schematically by underline for terms indicating part or symptom terms, and underline/bold for part/component terms:
BRAKE LINE FAILURE DUE TO CORROSION
VEHICLE COULD NOT BE STOPPED LINES
0.8 HRS INSPECTION BADLY RUSTED ALL BRAKE

I.D. Customer-Observable-Construction Module 183

With continued reference to FIG. 1, annotated output from the phrase-annotation module 182 is provided to the customer-observable-construction module 183

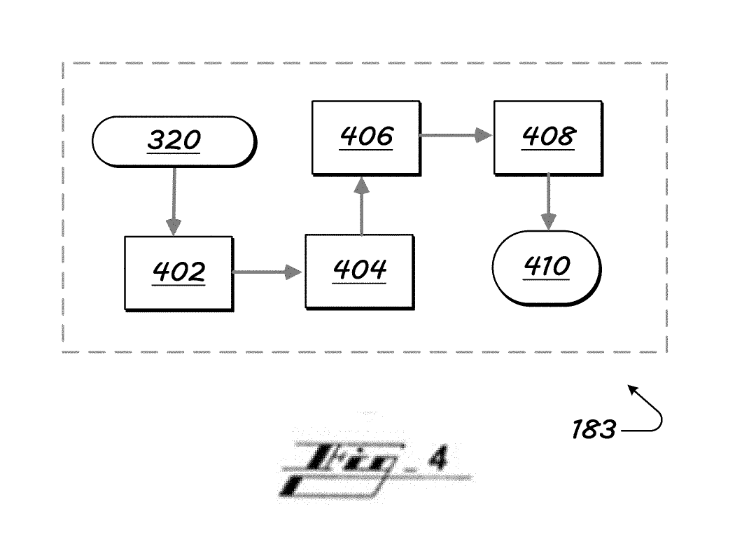

The customer-observable-construction module 183 generates at least one customer observable based on the annotated output 320. Sub-modules of the customer-observable-construction module 183 are shown by FIG. 4.

The customer-observable-construction module 183 includes an indices sub-module 402 that gets indices or indicia of the primary and secondary terms or phrases in the annotated output 320. An example indicia is proximity between a primary and a secondary term.

In various embodiments, a moving word window may be used to identify proximity between primary and secondary. The window may be applied either on the left side and/or the right side of a term under focus. In embodiments, the moving word window is a fixed parameter, and would should be customized—e.g., adapted, changed, and/or tuned for use in connection with one data source versus another data source. The length of the verbatim may be set based on the particular database being used, for instance.

At blocks 404, 406 forward and backward passes are performed. In various implementations, benefits to performing passes of the verbatim in both directions includes accommodation of the fact that various people (customers, service technicians, etc.) may say the same thing in various ways, including in different order. As any easy example, one technician may type a date by month/day, while another, day/month. Or one, “vehicle stalled” or “vehicle is stalling,” versus another, “stalled vehicle.”

At block 404, a forward-pass sub-module 404 performs a forward pass through the processed sentences for each ‘primary’ term/s or phrase/s. The pass is performed from left to right through the sentences. In the pass, the forward-pass sub-module 404 identifies associations amongst the primary terms or phrases, such as by grouping part/component terms with nearby symptom terms. The proximity requirement can be preset by a system designer, such as to be satisfied if a part term and a symptom term are within a preset number of words or spaces.

Continuing with the three-sentence verbatim above, the forward trace may be performed on the following three preprocessed phrases:
BRAKE LINE FAILURE DUE TO CORROSION
VEHICLE COULD NOT BE STOPPED
0.8 HRS INSPECTION ALL BRAKE LINES BADLY RUSTED

yielding the following forward-trace customer observables (COs):

BRAKE LINE < > FAILURE DUE TO CORROSION

FUEL SENSOR< >DOES NOT WORK

FUEL GAUGE< >STILL READS EMPTY

GAS TANK< >STILL READS EMPTY

FUEL SENSOR< >STILL READS EMPTY

A backward-pass sub-module 406 performs a backward pass through the processed sentences for each ‘primary’ term/s or phrase/s. The pass is performed from right to left through the sentences. In the pass, the backward-pass sub-module 406 identifies associations amongst the primary terms or phrases, such as by grouping part/component terms with nearby symptom terms. The proximity requirement again can be preset by a system designer, such as to be satisfied if a part term and a symptom term are within a preset number of words or spaces.

Continuing with the three-sentence verbatim above, the backward trace may be performed on the following three preprocessed phrases:
BRAKE LINE FAILURE DUE TO CORROSION
VEHICLE COULD NOT BE STOPPED
0.8 HRS INSPECTION ALL BRAKE LINES BADLY RUSTED

yielding the following backward-trace customer observables (COs):

BRAKE LINES < > BADLY RUSTED

GAS TANK< >DOES NOT WORK

FUEL GAUGE< >DOES NOT WORK

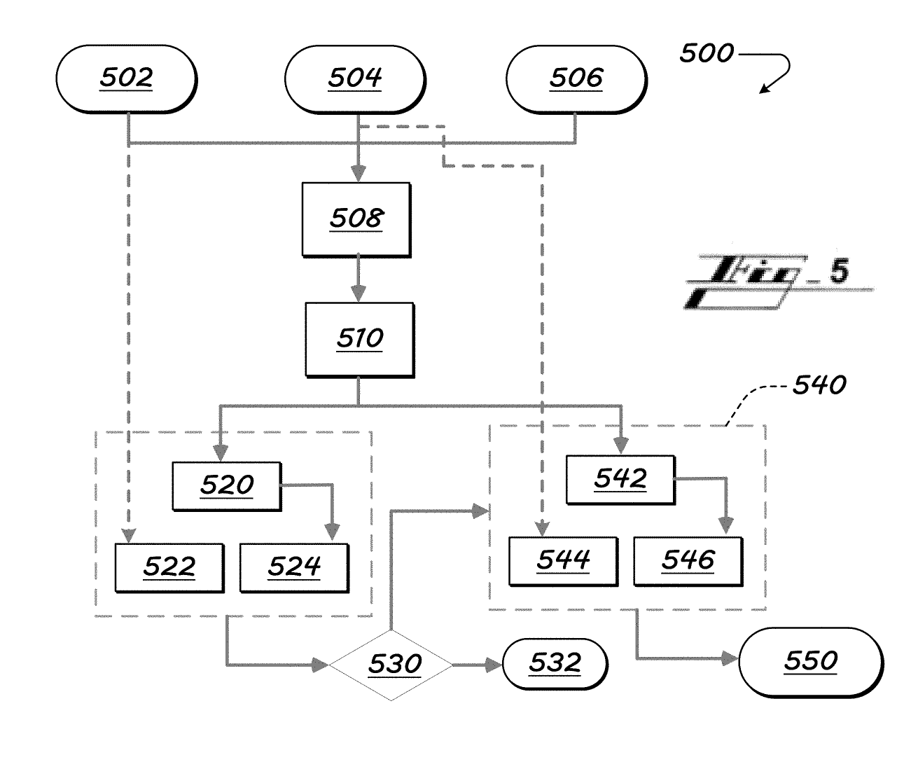

FIG. 5 shows customer observable (CO) construction steps, any of which can be used with or separate from those provided above. The arrangement 500 uses:
a primary map 502 (which can be represented in code as, (Map<String, TheOntoBin>);
a secondary map 504 (which can be represented in code as, (Map<String, theOntoBin>); and
an annotated term map 506 (which can be represented in code as, (eachVerb, eachSente, eachMatchedTerm, theStartIndex, theEndIndex, theMatchedTermType).

In contemplated embodiments, any of these maps may be part of the master ontology.

At least the first two maps are processed by a customer-observable construction sub-module 508.

At block 510, an initialization function is represented, which is performed using the annotated term map.

In various embodiments, the first two maps—the primary map 502 and the secondary map 504—are used to identify the parts (e.g., brake, steering gear, etc.) and related the symptoms—such as when the COs are of the form S1< >SY [part<>symptom]. The third, annotated-term, map 506 comprises complete information associated with the matched term, such as:
the verbatim from which the term is identified,
the sentence in each verbatim in which the term is mentioned,
the actual matched term (either part or symptom when the CO is of the form S1< >SY),
the start position of the matched term in a sentence,
the end position of the matched term in a sentence, and
whether the matched term is part or symptom (for the COs when the CO is of the form S1< >SY).

Part terminology, such as appropriate or relevant part terminology (e.g., related to a particular vehicle, situation, etc.), which can be referred to as a key, is obtained from the primary map 502 at block 522, for each Beanᵢ ∈ Annotate Term Map (block 520), and at block 524 a term type is obtained from the annotated term map. The term may be, for instance, based on the annotated term map, a part term, a verb term, a symptom term, or other.

Regarding block 520, it is noted that the primary map consists of the part term retrieved from the ontology (e.g., safety ontology) along with corresponding baseword(s). While identifying the critical terms in a verbatim, as described above, each verbatim is split into sentences, and then the part term from the primary map is identified from the sentence by using the co-location logic described above (see e.g., the resulting annotated term map referenced toward the end of section I.C). If the algorithm is looking for the part term—‘engine,’ for example, then the logic ensures that when it is mentioned as a substring—‘service engine soon’, for example—it is ignored. The position of a correctly identified part term(s) in a sentence—e.g., its start and end index—is captured, and used as one of the features by the machine-learning algorithm while constructing the COs.

Once the appropriate part terms (key) are identified, then for each part term, S1, all the symptoms (SY1, SY2, . . . , SYi) mentioned in the same sentence are collected. Next, the Euclidean distance between each part and all the symptoms (SY1, SY2, . . . , SYi) is calculated. The top two symptoms, say SYm and SYn with the closest Euclidean distance to S1 are used to construct the pair of the form ‘S1< >SYm’ and ‘S1< >SYn’, and they are maintained in what can be referred to as a ‘near CO collection’ (referred to as Cluster 1, below), whereas all other symptoms related to the part (S1) are maintained as pairs (S1< >SYx) in a ‘far CO collection’ (referred to as Cluster 2).

At decision 530, if there is not a match between the term type(s) of the key, from block 522 and the term type(s) from annotated term map 506 from block 524, then the process, or sub-process, 500 can end 532 with respect to the observable being formed.

If there is a match, flow proceeds to box 540. A term type is obtained from the annotated term map at block 546, for each Beanⱼ ∈ Annotate Term Map(block 542)

As referenced, the primary map consists of the part term retrieved from the ontology (e.g., safety ontology) along with corresponding baseword(s). While identifying the critical terms in a verbatim, as described above, each verbatim is split into sentences, and then the part term from the primary map is identified from the sentence by using the co-location logic described above (see e.g., the resulting annotated term map referenced toward the end of section I.C). If the algorithm is looking for the part term—‘engine,’ for example, then the logic ensures that when it is mentioned as a substring—‘service engine soon’, for example—it is ignored. The position of a correctly identified part term(s) in a sentence—e.g., its start and end index—is captured, and used as one of the features by the machine-learning algorithm while constructing the COs.

Part terminology, such as appropriate or relevant part terminology (e.g., related to a particular vehicle, situation, etc.), which again can be referred to as a key, is obtained from the secondary map 504 at block 544. The key obtained from the secondary map 504 (including, e.g., at least a symptom, SY) is used to calculate their Euclidean distance with respect to each S1 (as described above in 0162). The CO pairs are then constructed ‘S1< >SY’ and based their closest Euclidean distance they are classified either into ‘near CO collection’ (referred to as Cluster 1) and ‘far CO collection’ (referred to as Cluster 2).

Resulting customer observables are yielded at block 550. They may be represented in this case as follows:

Verbatim, Sentence, Primary, Secondary, Primar_{start index}, Primary_{end index}, Secondary_{start index}, Secondary_{end index}

Returning to the sub-modules and flow of FIG. 4, a CO-sorting sub-module 408 sorts, classifies, clusters, or otherwise simplifies the resulting forward- and backward-obtained COs for use in the next stage or processing.

The sorting may include, for instance, removing redundant COs, grouping COs having the same or similar parts/components, such as those having as the part, “BRAKE LINE” and/or “BRAKE LINES.” And/or grouping COs having the same or similar symptoms.

In one implementation under the example presented, the COs are grouped or clustered into two clusters, distinguished as near, or nearer-spaced, and far, or father-spaced, group pairs:

Cluster 1 (near, or nearer-spaced, group pairs)

BRAKE LINE< >FAILURE DUE TO CORROSION

BRAKE LINES< >BADLY RUSTED

FUEL SENSOR < >DOES NOT WORK

FUEL GAUGE< >STILL READS EMPTY

GAS TANK< >STILL READS EMPTY

Cluster 2 (far, or farther-spaced, group pairs)

FUEL SENSOR < >STILL READS EMPTY

GAS TANK< >DOES NOT WORK

FUEL GAUGE< >DOES NOT WORK

A third cluster, Cluster 3, is formed by a union of the first two:

Cluster 3=Cluster 1 U Cluster 2

A proximity analysis may be performed, such as a Euclidian analysis to determine relationships amongst terms, or importance of pairings.

In various embodiments, the following classification logic is used:
1. If there is one part and one symptom, Cluster 1
2. If there are more than one part or, more than one symptom, then,
   For each ‘Partᵢ’ get the distances of all ‘Symptomⱼ’, which are on the left & right side of ‘Partᵢ’
   Identify ‘Symptomₖ’ having the Minimum Euclidean Distance with ‘Partᵢ’, and such pair of (Partᵢ Symptomₖ) is assigned to Cluster 1
   All other pairs of (Part Symptomn) are assigned to Cluster 2
   In each Cluster 1 & Cluster 2, calculate the difference of start indices between Partᵢ and Symptomⱼ that are member of each COᵢ, and sort the pairs in descending order.

With final reference to FIG. 4, the sorted (classified, clustered, or otherwise simplified) COs are represented by oval 410 in FIG. 4.

I.E. Customer-Observables-Merging Module 184 and

Pointwise Mutual Information Module 185

A customer-observables-merging module 184 performs merging operations in various embodiments to limit the customer observables constructed to the most valuable, or critical customer observables 190.

Merging addresses similar or overlapping terminologies in constructed customer observables in various embodiments. For instance, if one CO includes ‘lost power’ and another ‘stall’, all else being the same, those two can be combined, or one removed.

In some embodiments, the functions are performed to identify criticality of all customer observables, so that the more critical customer observables are known and can be given more weight or prioritization in later use of the observables.

The pointwise-mutual-information (PMI) module 185 performs PMI functions to gauge or determine levels of severity associated with a subject product issue, by assessing severity represented by each customer observable and/or by an entire CO set formed from one or more verbatims regarding the product. Limiting the scope first to customer observables, and then here further to the top issues, provides very valuable and usable output data 190.

PMI functions can be performed on merged data, as indicated by the arrowed line leaving the merging module 184 and/or on pre-merged data, as indicated by the dashed arrowed line to the PMI module 185.

The merging functions of the COM module 184 may be performed using, or in conjunction with the functions of the pointwise-mutual-information (PMI) module 185. In a contemplated embodiment, the two modules 184, 185 are combined into a single module. The combined module can be referred to by any of a variety to terms, such as still the COM module, the COM/PMI module, the like or other.

A base example PMI function process a probability of the primary and secondary term occurring [(P(primary, secondary)], and the separate probabilities of the primary term occurring [P(Primary)] and the secondary term occurring [P(Secondary)], are calculated over the sample of the total number of COs extracted out of data (N):

$$PMI ( Primary , Secondary ) = {log}_{2} \frac{P ( Primary , Secondary )}{P ( Primary ) P ( Secondary )}$$

A counting function, “(C(.))” may be applied toward obtaining a maximum likelihood estimate. A designer of the system can program the system as desired regarding what qualifies as a ‘Primary/Secondary’ co-occurrence.

$$P ( Primary , Secondary ) = \frac{\frac{c ( Primary , Secondary )}{N}}{\frac{c ( Primary ) c ( Secondary )}{ N N }} = \frac{c ( Primary , Secondary )}{N} \frac{{N}^{2}}{c ( Primary ) c ( Secondary )} = \frac{c ( Primary , Secondary ) N}{c ( Primary ) c ( Secondary )}$$

wherein, N is a sample size, depending on the task. In embodiments in which a list of pairs or primary, secondary are ranked, N could not be used because it would be the same for all of the pairs.

Taking a logarithm of:

$$P ( Primary , Secondary ) = \frac{c ( Primary , Secondary ) N}{c ( Primary ) c ( Secondary )}$$

$$given \text{:}$$

$$log ( A \times B ) = log A + lobB$$

$$log \frac{A}{B} = log A - log B$$

$$yields \text{:}$$

$$PMI ( Primary , Secondary ) = {log}_{2} ( c ( Primary , Secondary ) ) + {log}_{2} ( N ) - {log}_{2} ( c ( Primary ) ) - {log}_{2} ( c ( Secondary ) )$$

In various implementations, c(Primary, Secondary)=c(Primary)=c(Secondary)=f, and the core formula becomes

$$\frac{f}{{f}^{2}} .$$

Because f doesn't grow as fast as f², PMI will decrease as f becomes larger.

| f | f/f² |
|---|---|
| 1 | 1 |
| 2 | 0.5 |
| 3 | 0.33 |
| 10 | 0.1 |
| 100 | 0.01 |
| 1000 | 0.001 |

Thus, counterintuitively, a highest possible PMI results for words that occur once, and those that they occur together.

While frequency threshold often produces excellent results, they can be relatively arbitrary, depending on corpus size. A better approach in various implementations is to use association measures (AM) that take absolute observed frequency into account, such as a weighting absolute observed frequency by PMI:

$$P ( Primary , Secondary ) = c ( Primary , Secondary ) * {log}_{2} \frac{P ( Primary , Secondary ) N}{P ( Primary ) P ( Secondary )}$$

[wherein C(primary, secondary)=Absolute observed frequency]

[wherein, regarding the loge fraction, the two distributions have the same underlying parameters, represented by {P(Pri), P(Seco)|P(Pri)=P(Seco)}]

$$P ( Primary , Secondary ) = c ( Primary , Secondary ) * {log}_{2} \frac{c ( Primary , Secondary ) N}{c ( Primary ) c ( Secondary )}$$

$$P ( Primary , Secondary ) = c ( Primary , Secondary ) * ( {log}_{2} ( c ( Primary , Secondary ) ) + {log}_{2} ( N ) - {log}_{2} ( c ( Primary ) ) - {log}_{2} ( c ( Secondary ) ) )$$

In various embodiments, this resulting function is a core of the algorithm for computing criticality of newly constructed customer observables.

If two customer observables, CO1 and CO2, have the same probability, any of the following can be used:
Compute their probability with different subset data sample, such as by obtaining or creating different data samples for use in analyzing the combination. The various data samples may relate to, for instance, different model years of the same product, different makes, or models. By this operation, CO1 and CO2 may show different probability within one or more of these data sets.
Compute their probability with different time periods, such as by separately using data corresponding to each 2014, 2015, 2016, etc., to see if CO1 and CO2 show different probabilities in these data sets.
Identify a particular primary, and if a particular Primary is identified as being mentioned in either CO1 or CO2, then give more weight to the occurrence. The primary map can be that referred to above in connection with reference numeral 502, used to identify the primary term(s) associated with customer observable(s)—e.g., CO1 and CO2. If the S1 (i.e., primary part) of CO1 and the S1 of CO2 are semantically similar with each other then these two S1s are considered to be the same.
If any of the product part/component in the Primary shows more criticality when mapped to a VPPS hierarchy, then give more weight to the occurrence. The VPPS hierarchy describes and manages vehicle content—e.g., part terminologies—globally agreed-upon and used consistently across various organizations, groups, and/or activities.
In various embodiments, a VPPS functional view generated breaks the vehicle down to subsets, such as chassis, electrical, and exterior. If a primary element of a specific CO is associated with the part/component in the VPPS hierarchy and the part-component affects vehicle operation, such as if the part if not working properly can result into stalling, malfunction, a walk-home scenario, etc., then the part or pair is given more weight compared to a part(s)/component(s) related to other parts or areas of the vehicle, such as related to trunk, interior lighting, etc.
In various embodiments, a subject matter expert (SME), or system programmed by an SME, may be consulted to determine which COs are more important. Such determinations may be stored in a knowledge database for automatic use dynamically in like situations going forward.

At a sentence level, the customer observables are classified into closest and others. In various embodiments, the distinctions may be drawn as follows:
1. closest pairs—if there is more than one part/component or one symptom specified, then the symptom/s closest (e.g., Euclidean distances, character spacing, or word separation) to the part/s are associated with the part/s based on their relative positions;
2. other pairs—when symptoms are farther, as compared to the closer pairs, for instance, the symptoms farther are still associated, but under other pairs, which in some implementations are given less weight.

Any one or more of three implementations of the PMI model are used in various embodiments:
Model 1. Estimate the criticality of the customer observables that are classified into closest pairs, whereby N, referenced above, is the sample size, or total number of closest customer observables.
Model 2. Estimate the criticality of the customer observables that are classified into other pairs, again using the N sample size.
Model 3. Estimate the criticality of all customer observables at a corpus level, based again on the N sample size.

As referenced, the CO data can be used by personnel, computers, any of various departments, groups, or organizations, such as of a company,—e.g. safety, service, quality, manufacturing, engineering, etc. of a CRM, or automated machinery in various ways, such as to repair a vehicle, communicate an instruction, such as to all dealerships, regarding how to repair a vehicle, to improve a product design, or improve a product-making process, as just a few examples. In various embodiments, the customer-observable output is sent to a destination for analysis and implementation of correction or mitigation activities by an output module, or the output module analyzes and implements the correction or mitigation activities itself, such as diagnosing the problem, and recommending, initiating, and/or making a needed repair. Robotics may be used to make a needed repair, for instance.

In a safety organization, for instance, the data can come from various sources, and it is critical to effectively and efficiently identify the faults pertaining to indicated systems. The data is transferred as input to the customer observable extraction algorithm and the newly extracted COs are sorted based on PMI from highest to lowest. The critical COs (according to PMI) help safety department, group, or organization, such as of a company, to focus their attention to the Make/Model/MY and the system associated with fault/failure. They can take necessary action such as report related divisions to improve design/engineering/manufacturing of components or contact supplier supplying faulty components, and finally in cases in which the vehicle(s) involved in faults/failures are recalled. The service and quality organizations make use of the COs to discover the failures observed during the warranty period of vehicles and can automatically, e.g., without human involvement, identify the suppliers supplying the components.

In cases where the fault is due to the legacy issues, the engineering or the design division are contacted, which again can be automatic, to make the necessary changes to the process, or design, or manufacturing.

In an implementation, the computing systems of a quality division of an OEM can employ the CO extraction algorithm of the present technology on data related to a test fleet of vehicles to identify faults before the vehicle design is finalized and/or before vehicles are shipped to a dealership or other seller or user.

In an implementation, data associated with vehicles from early months-in-service (e.g., two or three months-in-service) is used to discover failure signatures, or vehicle characteristics that indicate presence, likelihood, or high likelihood of a present or future malfunction, failure, or issue, and so protect a larger vehicle population, such as a second run of the vehicles.

II. Reducing False Positives

Another aspect of the present technology includes a machine-learning algorithm to identify features in text data that allow classification of extracted customer observables, which can be used to reduce false positives.

The algorithm is used to train the system to automatically classify extracted customer observables into true positives and false positive classes. This is performed initially, in some embodiments, using a very small amount of training data, which include unstructured data received from a raw-date source (a VOQ source, a GART source, etc.).

By confirming accuracy of customer observable formation regarding initial samples, such as small training samples, efficacy of the extraction algorithm in a much larger database from which the sample was drawn, or a future or subsequent sample, can be improved by updating the algorithm accordingly.

Various tunings of the extraction algorithm can be chosen automatically based on a summary of features in any new database to be mined. For example, a feature of, ‘distance between primary and secondary in characters,’ can be customized for a particular data source, based on a pre-determined length of verbatim related to a database. As an example, regarding GART, the typical length of a verbatim may be three sentences, with each sentence consisting of 5 to 7 words, with three technical words; while, on the other hand, regarding a VOQ, the typical length of a verbatim may be 8 to 10 sentences with each sentence consisting of 7 to 9 words and 2 to 3 technical words. Given different distributions, the distance between primary (faulty part) and secondary (associated symptom) can be estimated and tuned in order to generate high-quality COs.

Similarity, PMI value(s) may be adapted depending on the number of COs extracted from the data sample and the probability of (primary_term secondary_term) as well as probability of (primary) and probability as (secondary) estimated on the data sample size, to determine appropriate PMI value threshold that can be selected such that COs below the threshold can be marked as the false positives.

In identifying false positives in the sample, for use in subsequent machine learning, an example feature that can be associated with a false positive identified is transitivity, or spacing between secondary and primary terms of the pair (primary term, secondary term) that should not have been formed.

The approach is a novel manner to identify and classify customer observable features using the machine-learning algorithm.

By reducing false positives, the customer observables remaining or from subsequent CO identifications are even more useable and effective for automated parsing of many—e.g., millions—of unstructured text data points (i.e., unstructured verbatim), as the false positives can be easily identified early and removed, or not further read, or otherwise processed, such as by extracting or otherwise associating with a critical-fault signature and using in subsequent analysis of vehicles or data.

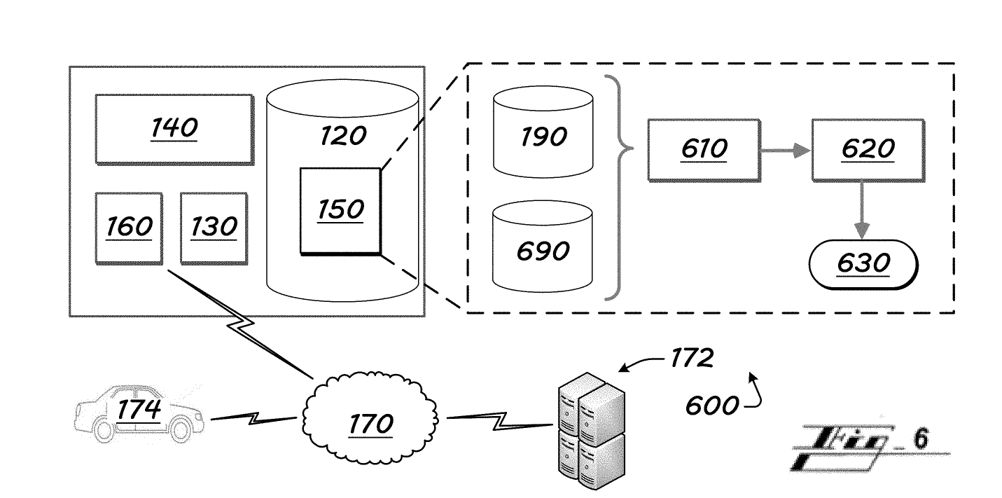

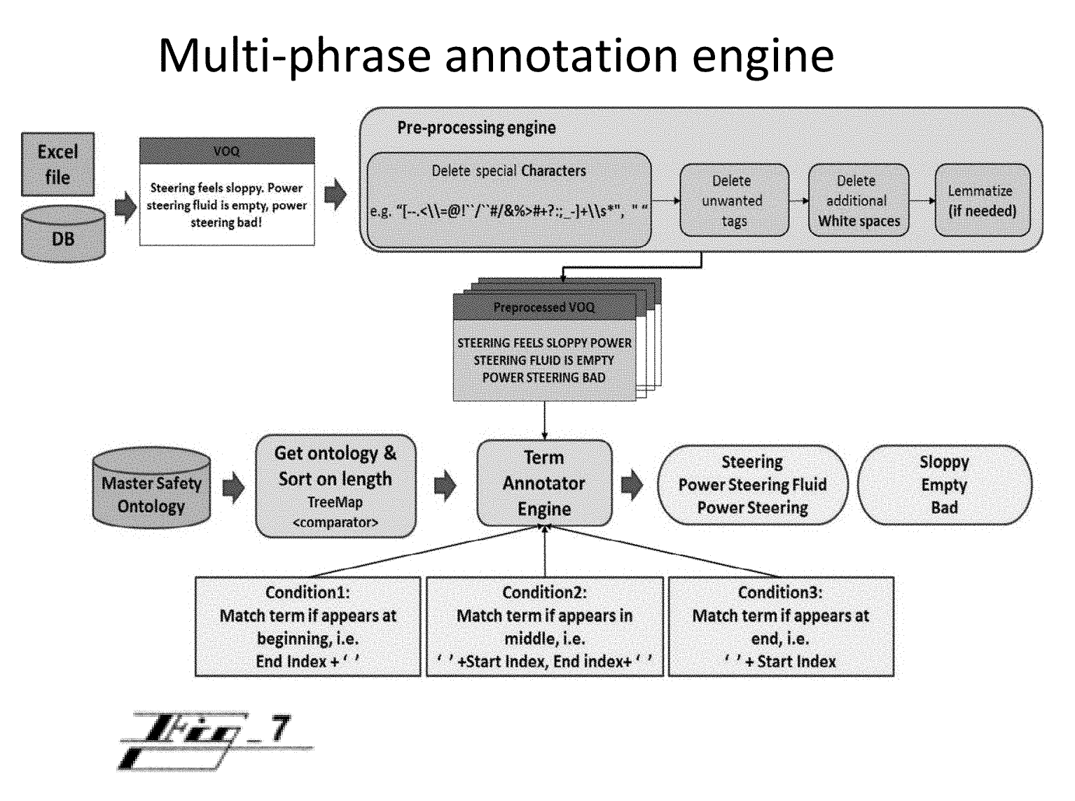

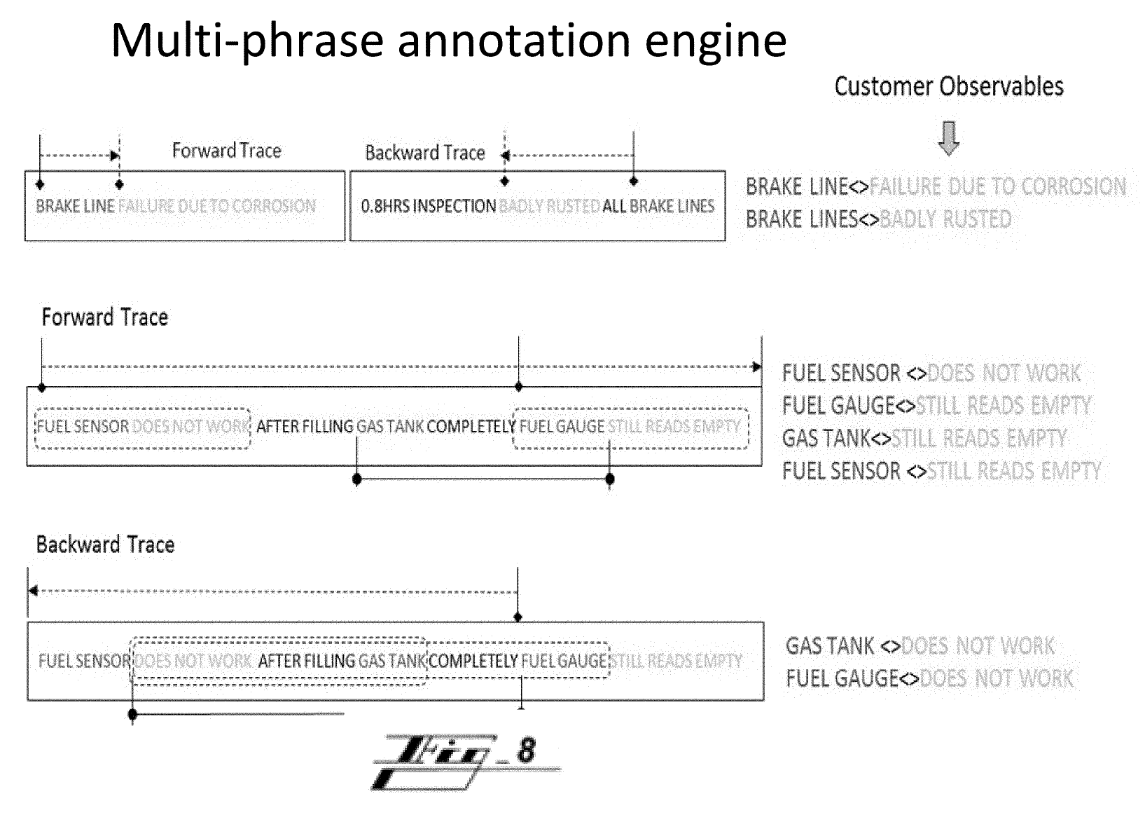

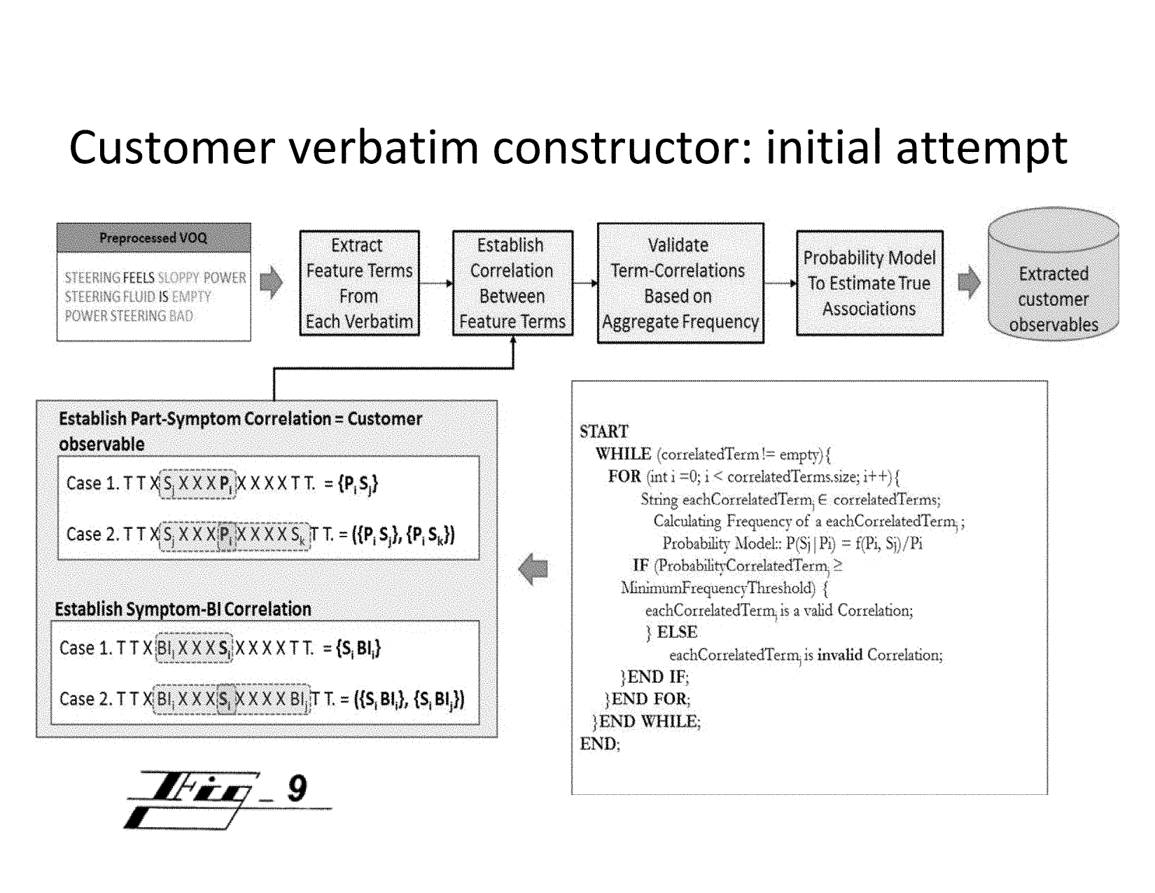

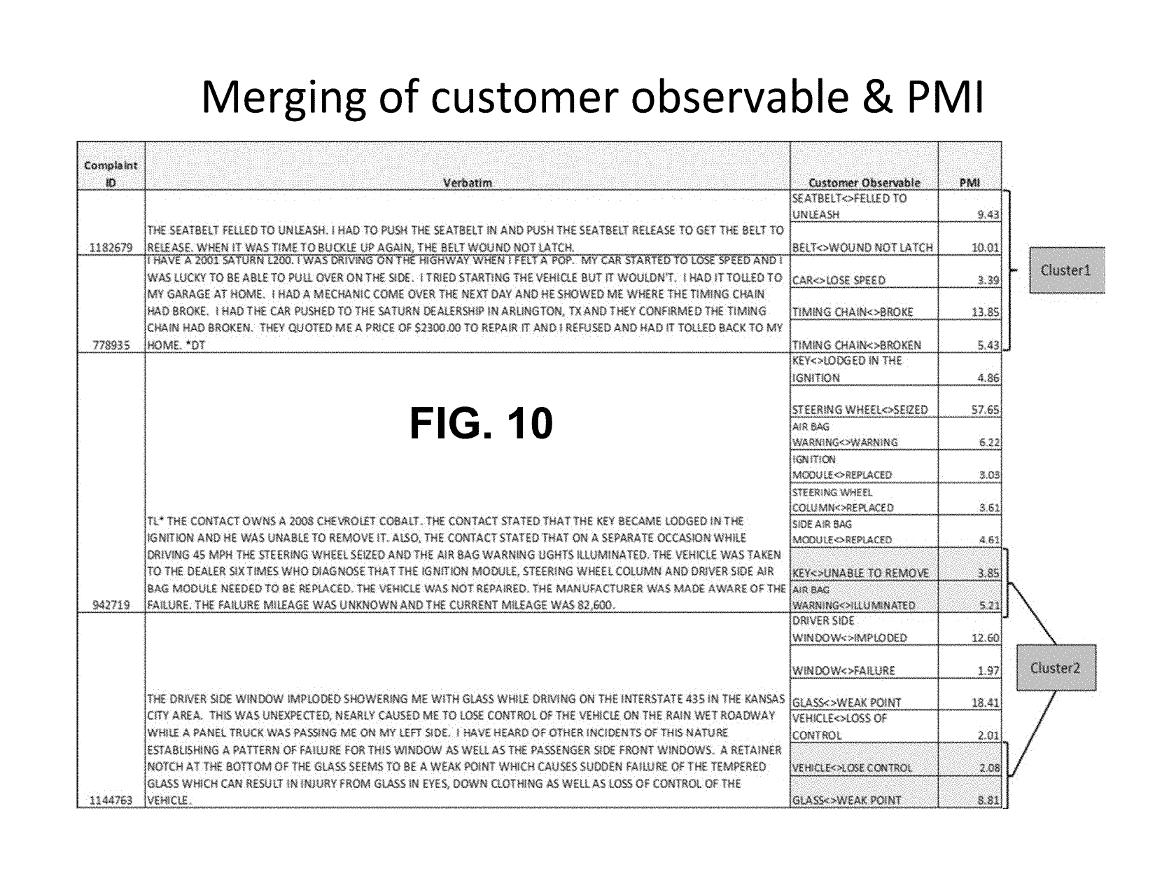

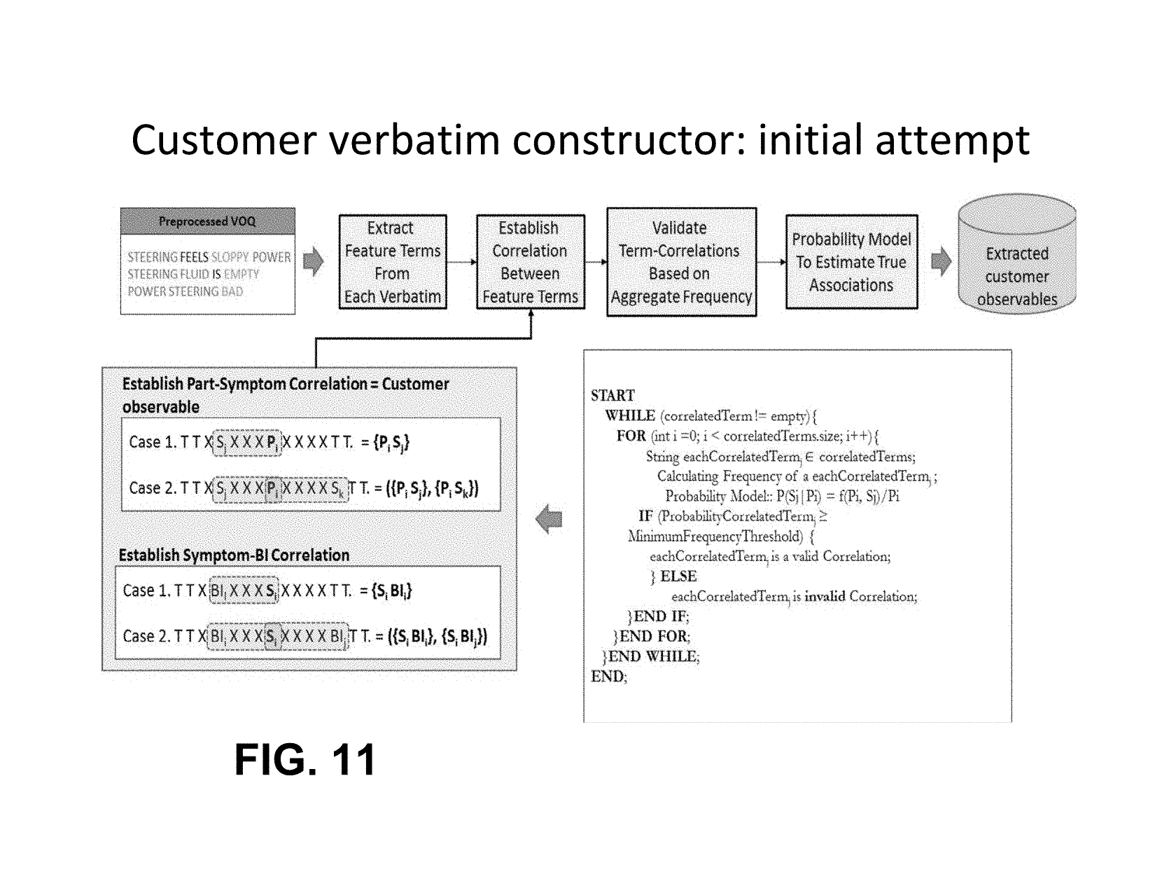

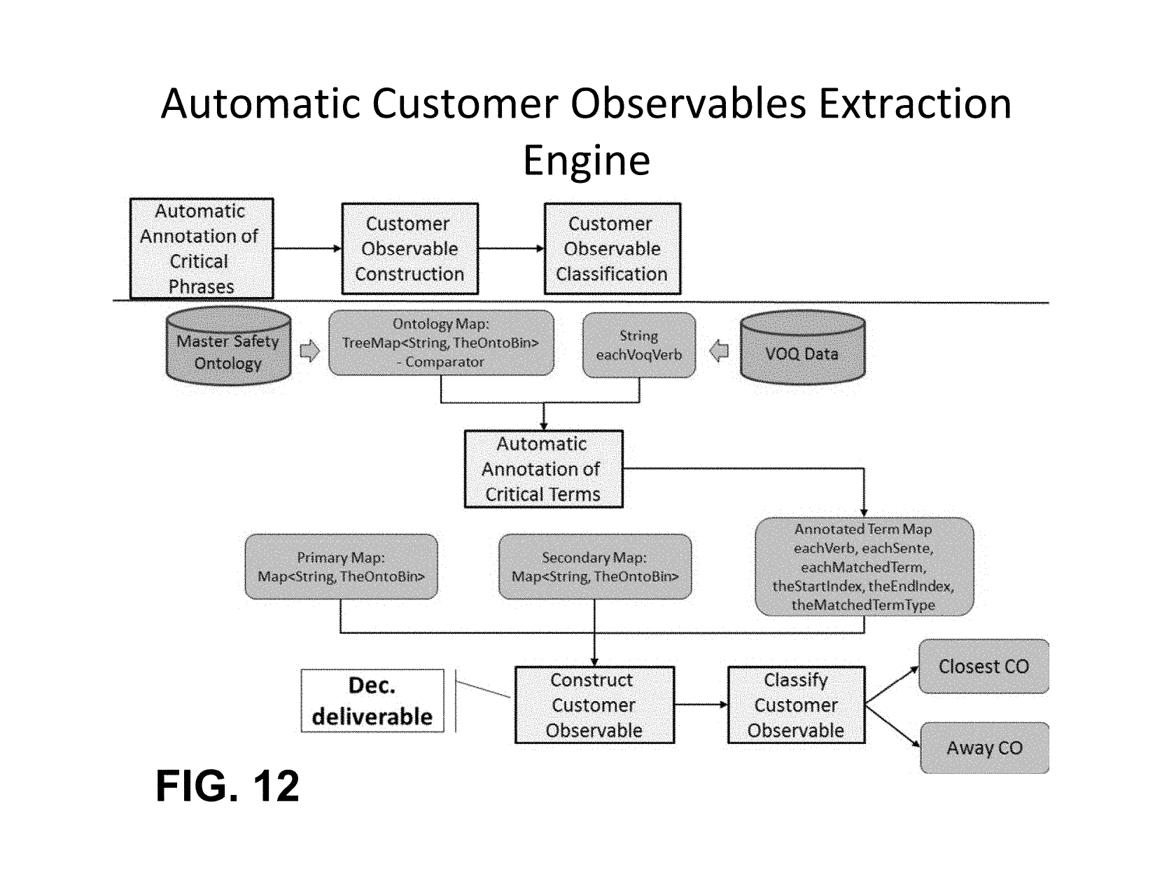

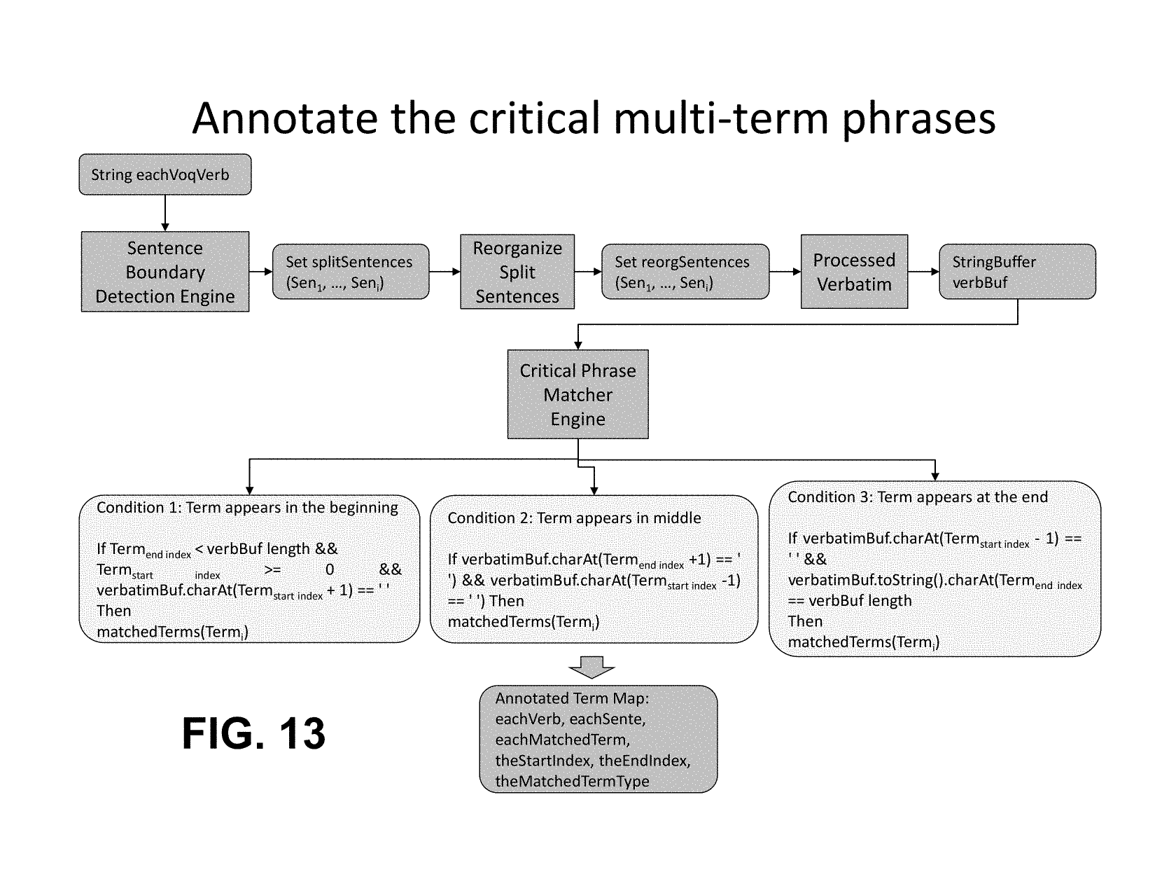

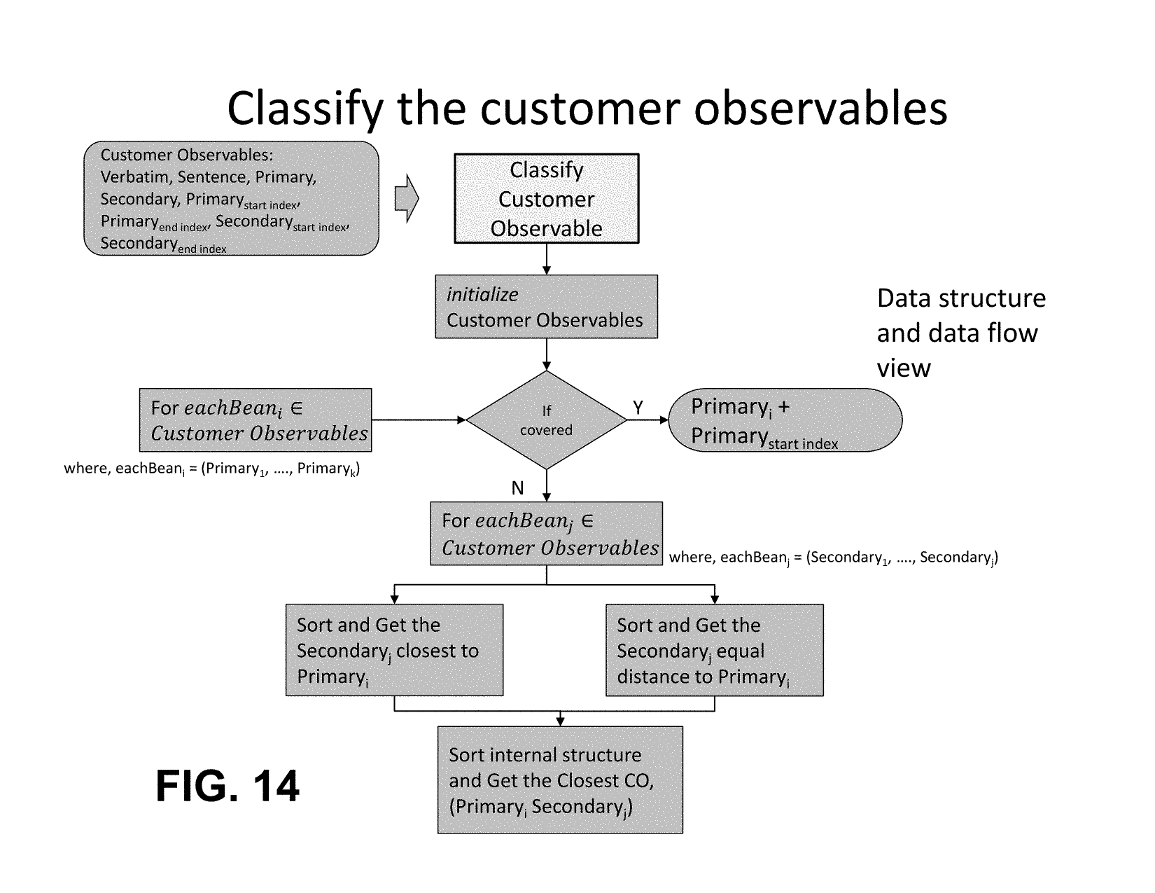

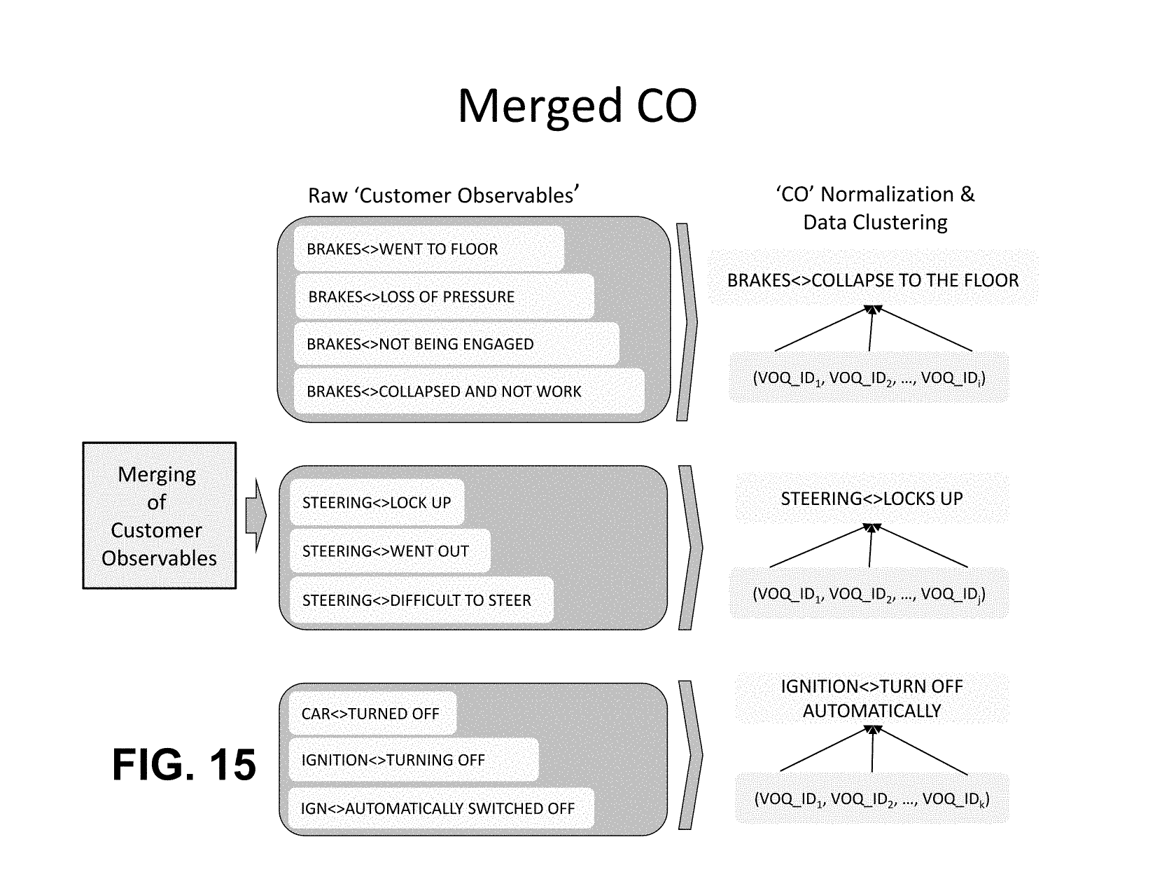

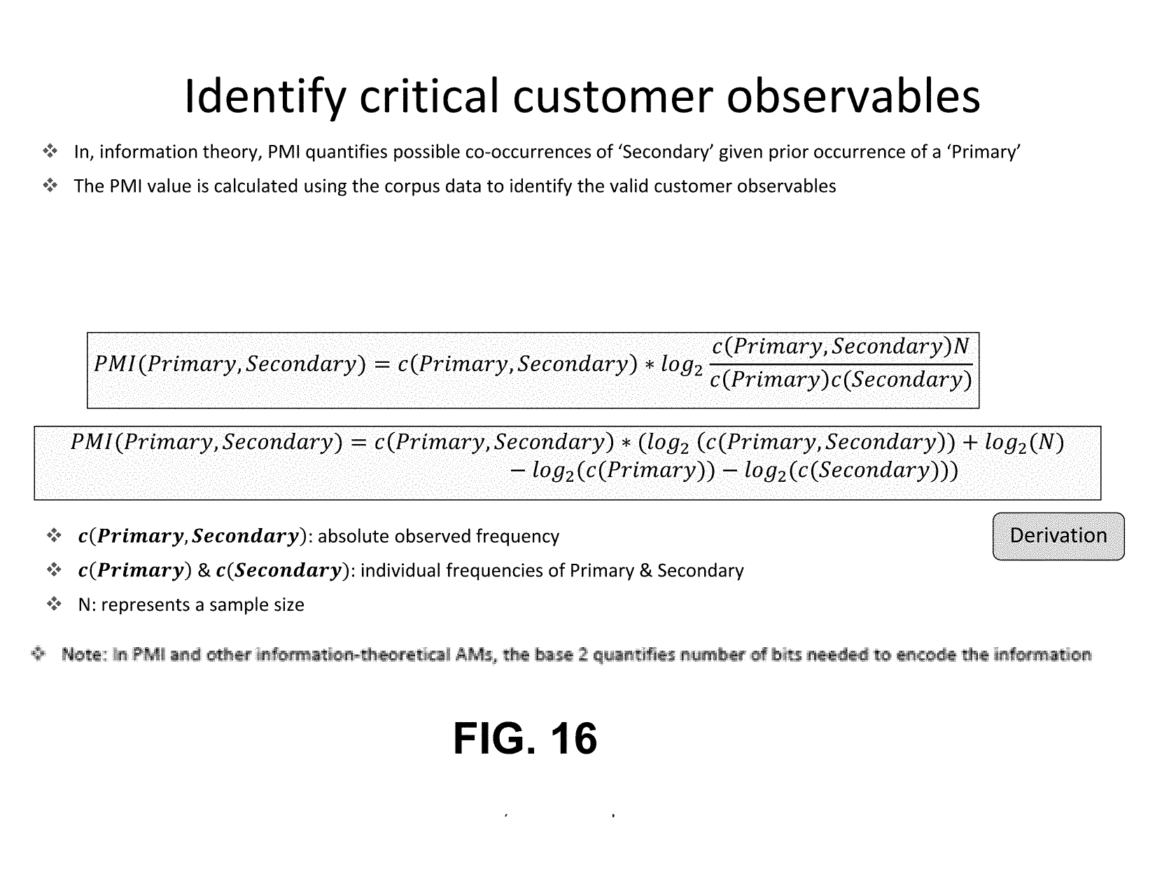

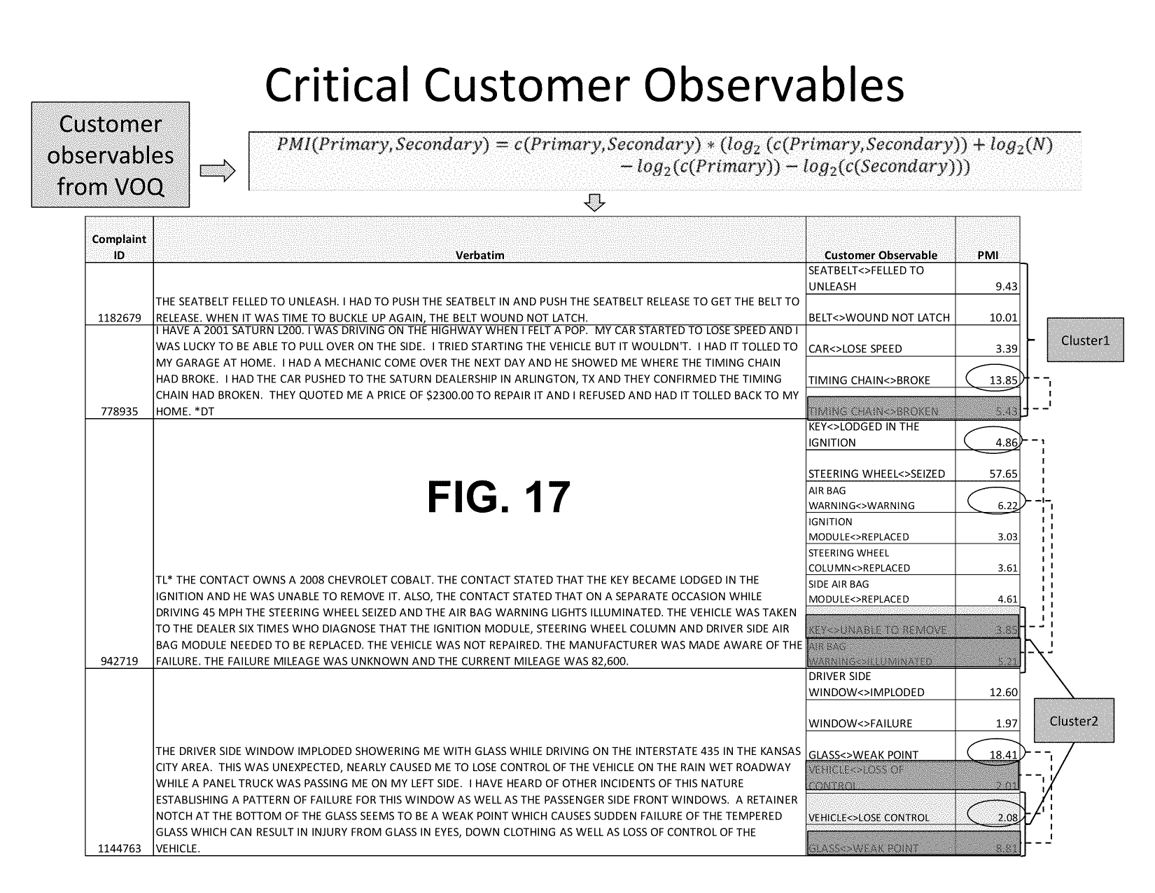

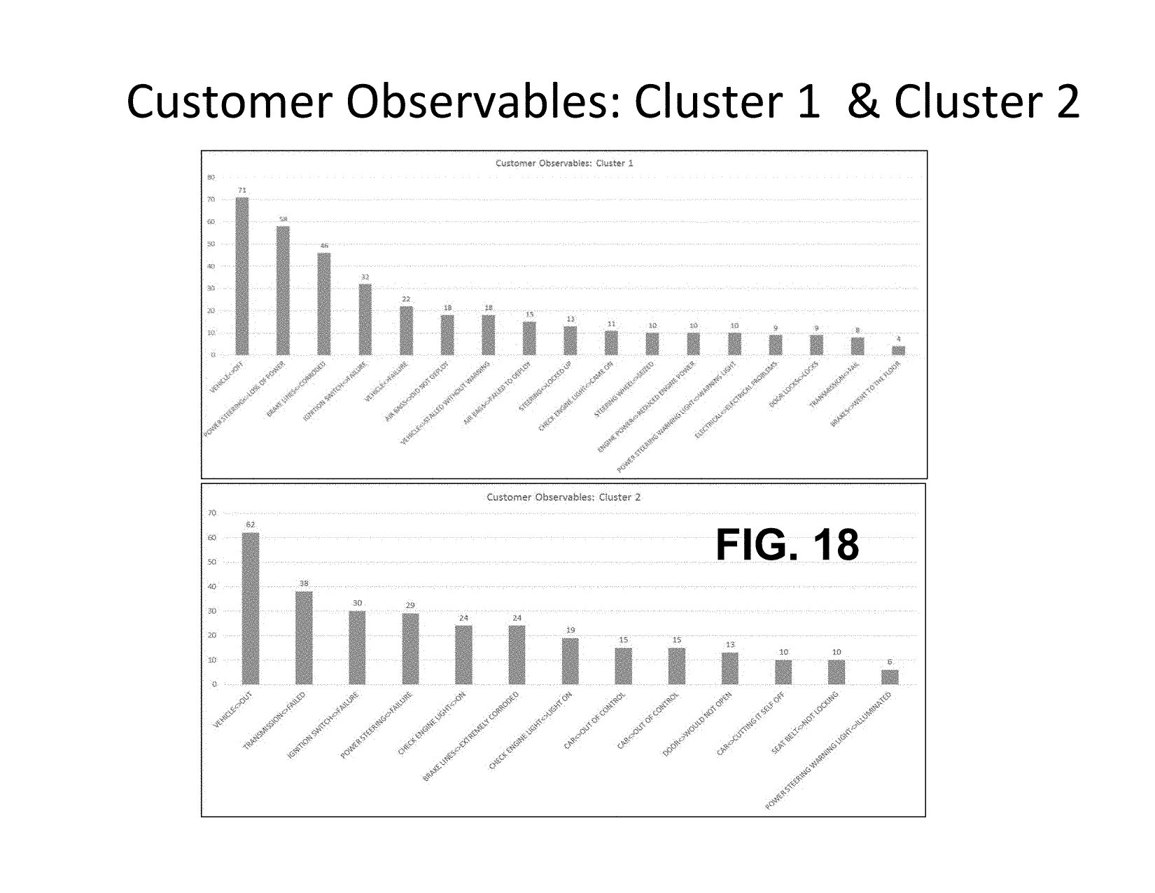

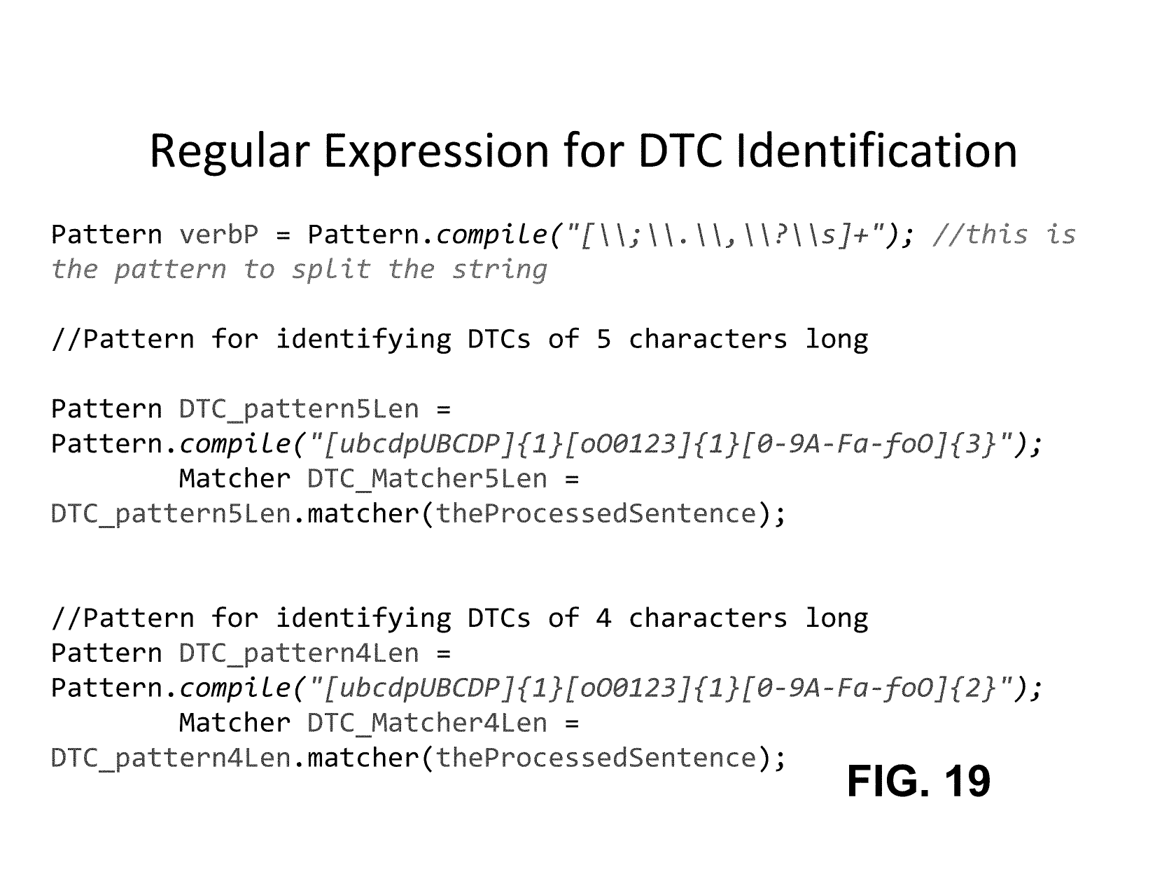

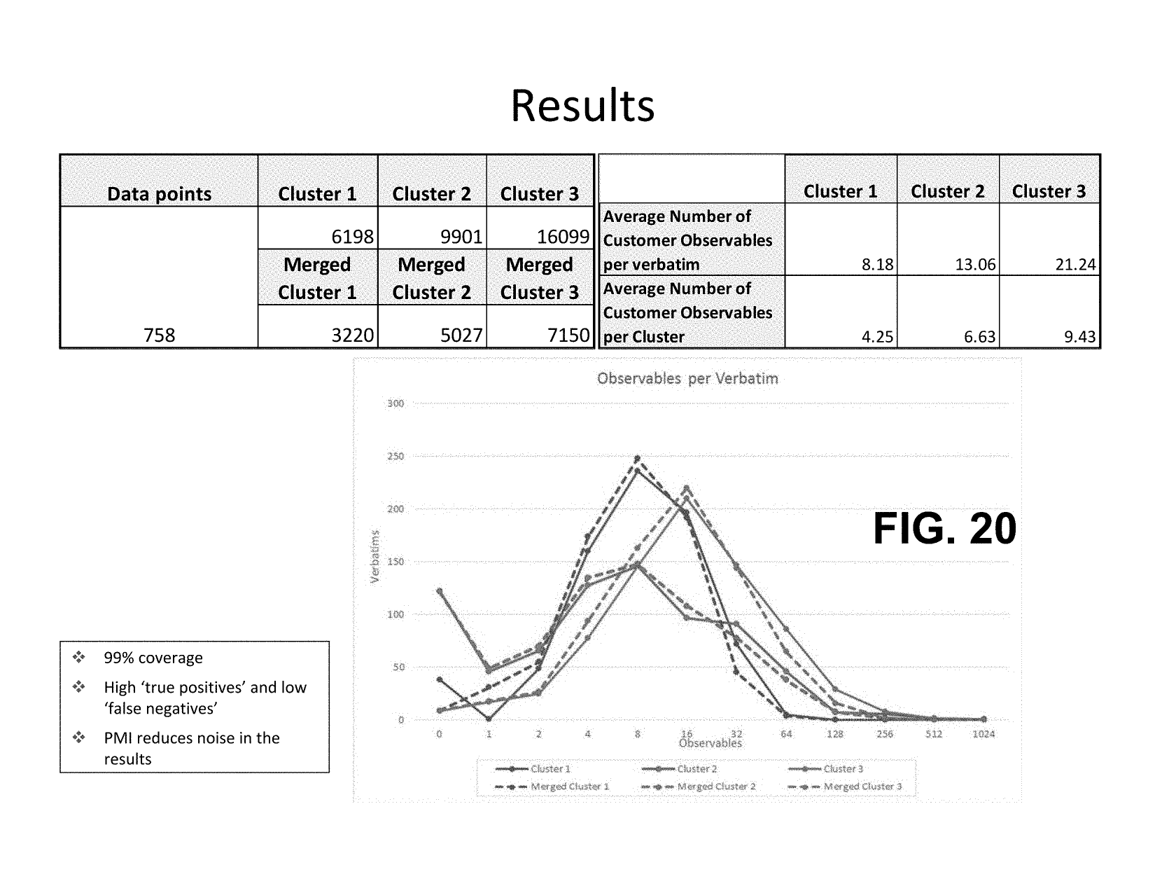

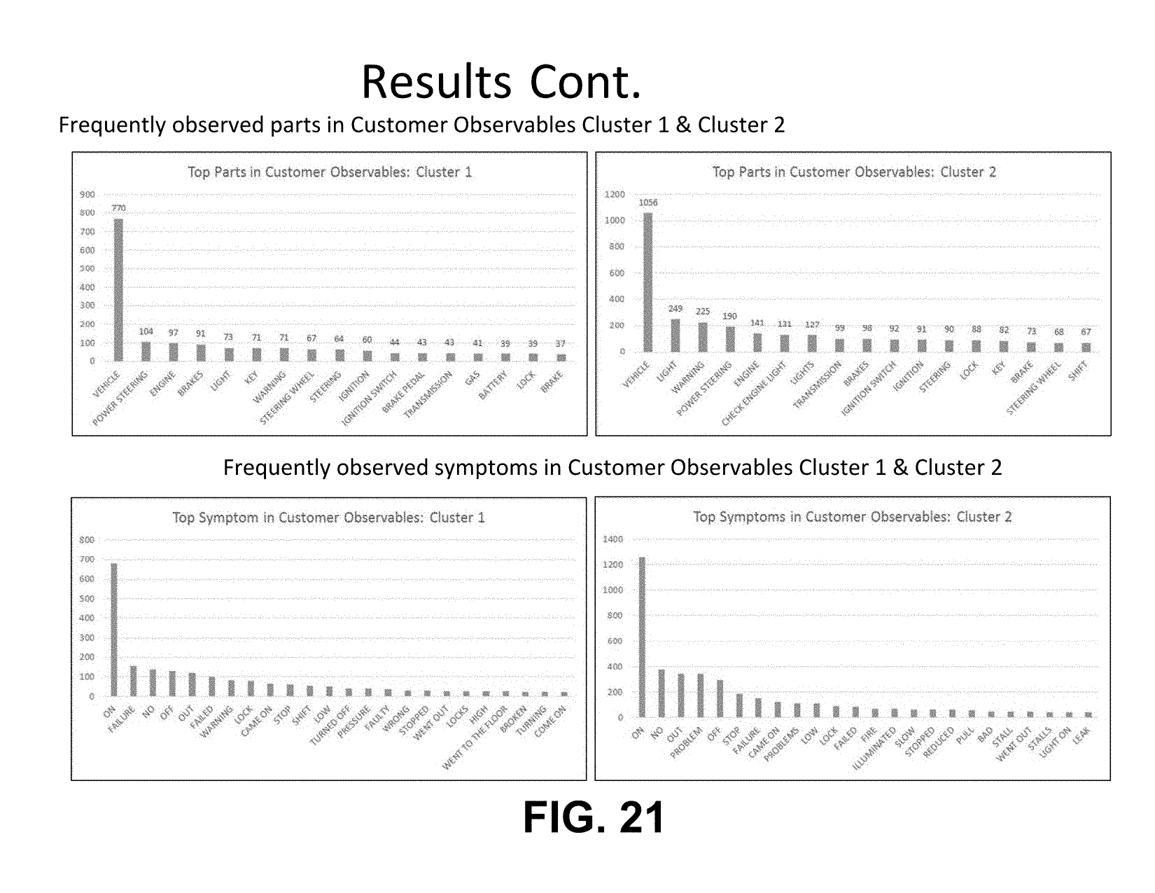

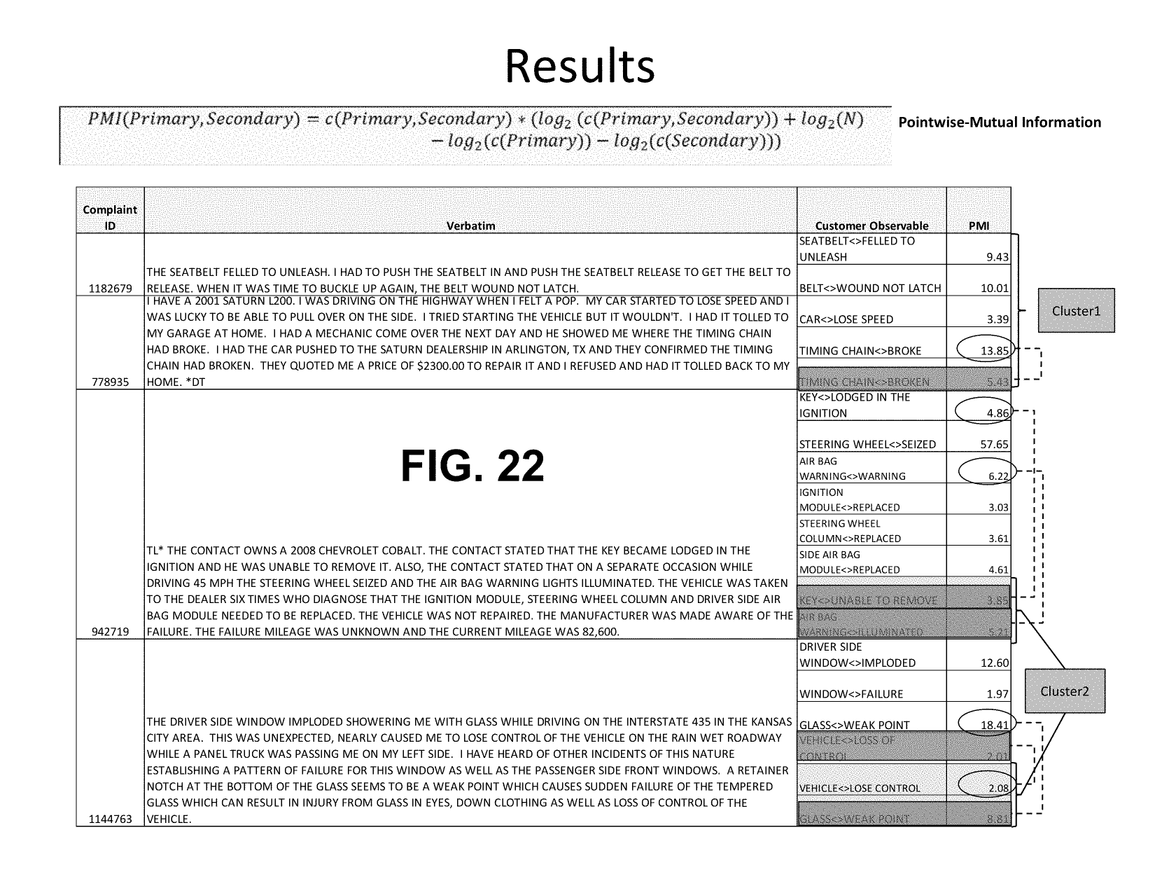

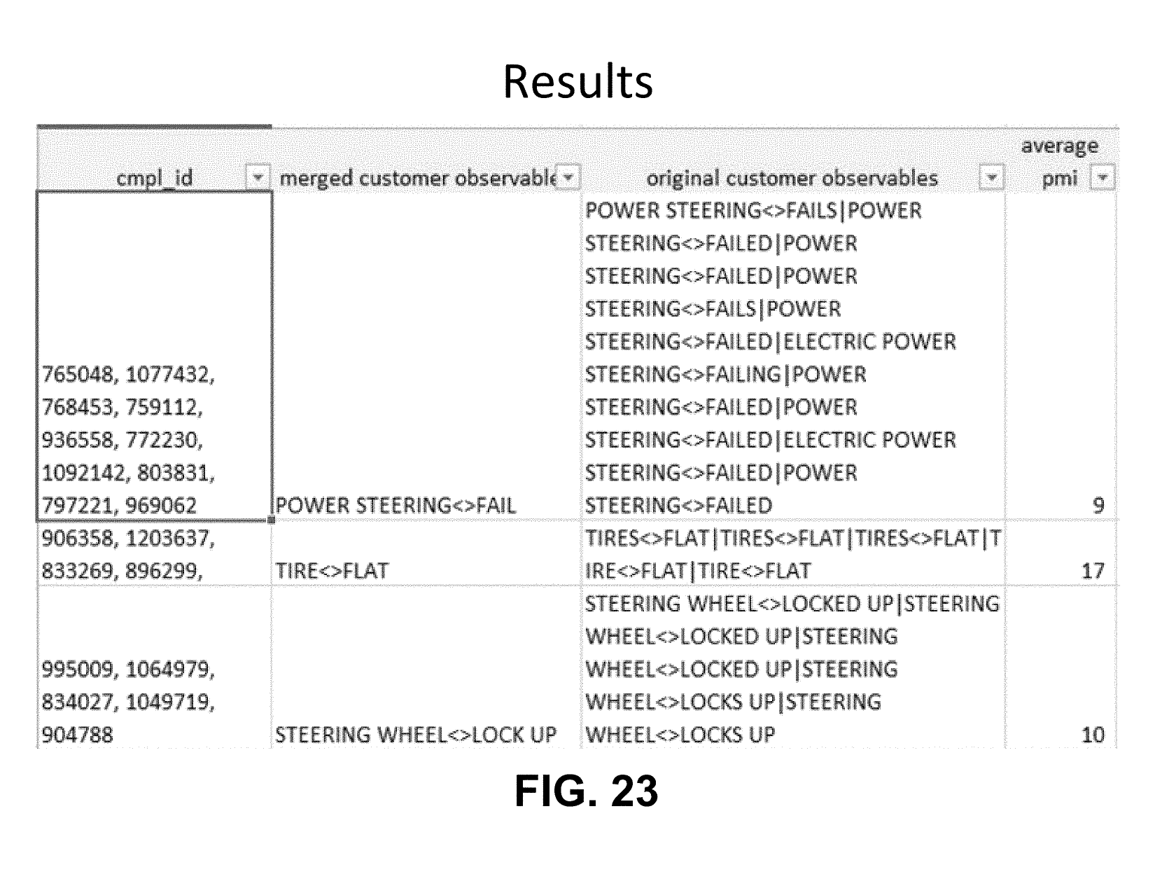

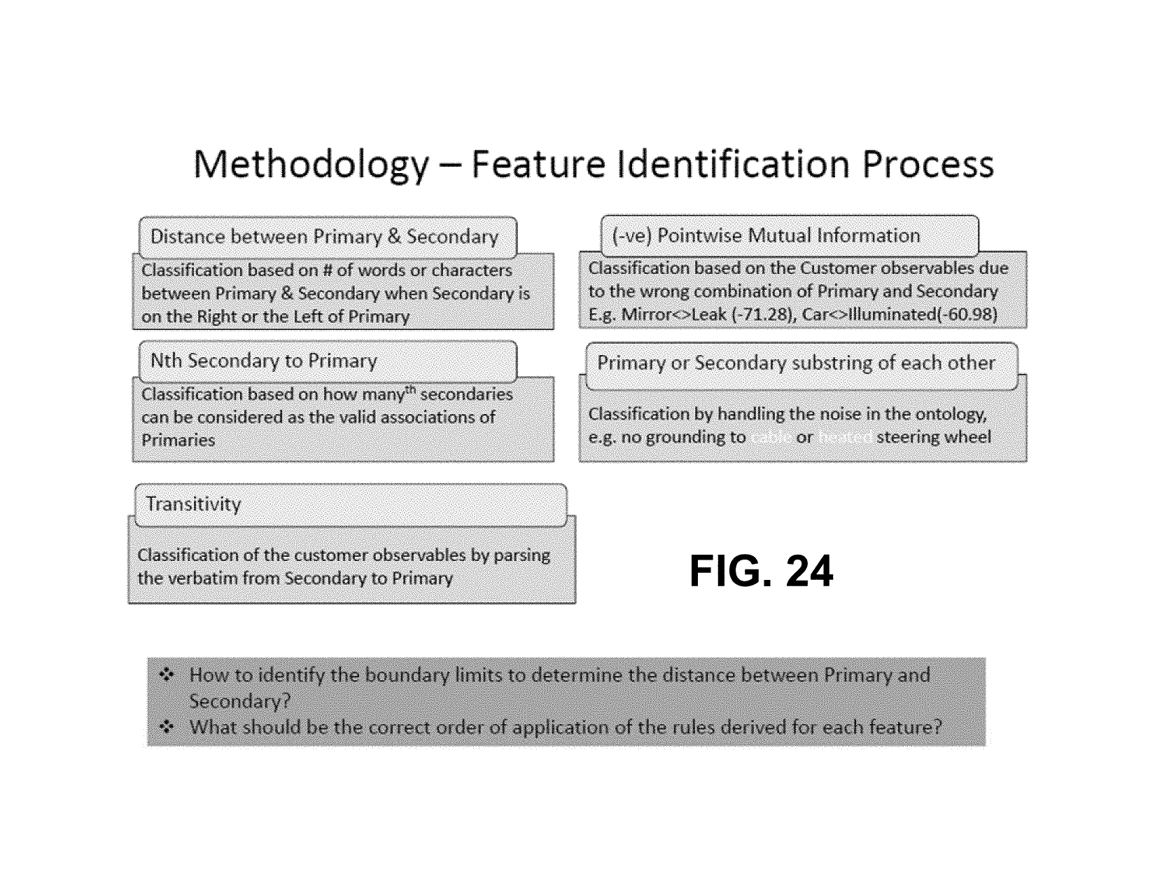

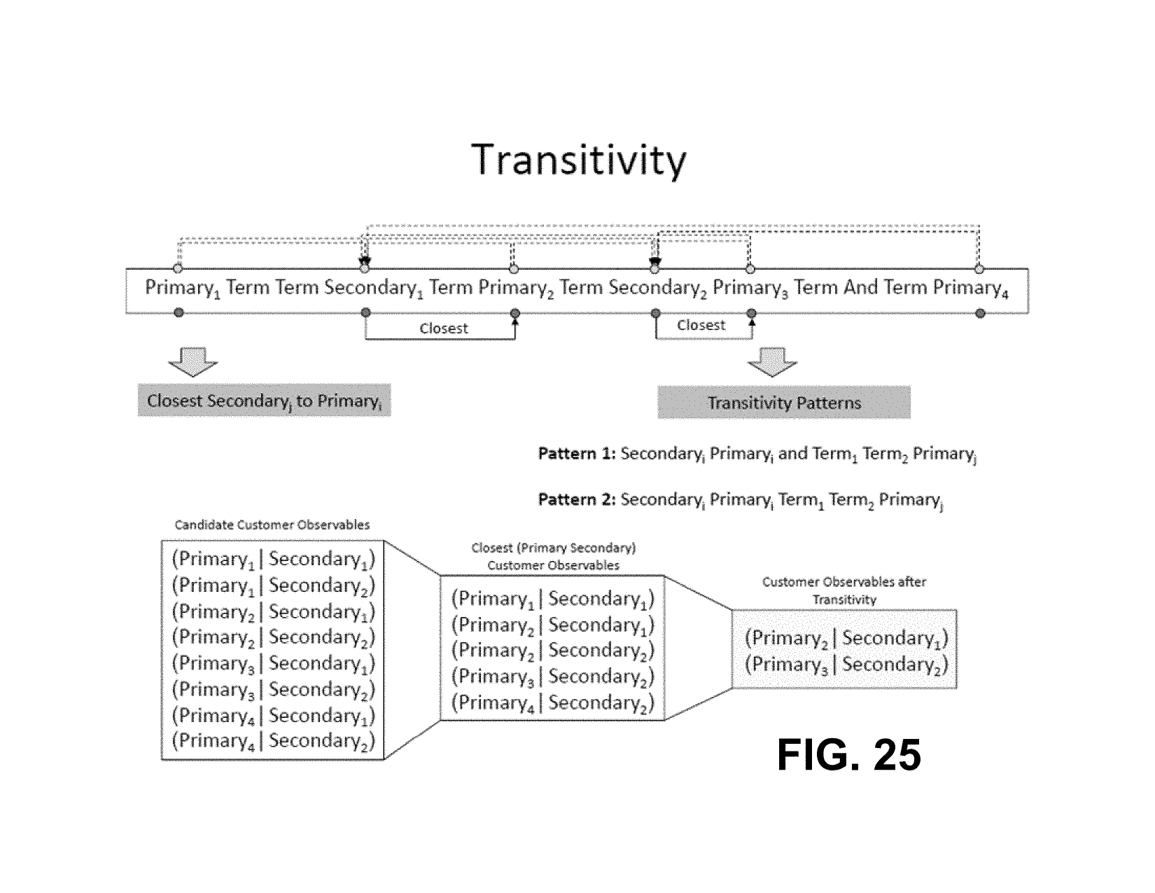

FIG. 6 shows an environment 600 like that of FIG. 1, with some different structures—e.g., modules and code—shown at the right.

The structures of FIG. 6 include the customer observables 190 from FIG. 1, and a distinct, SME database 690.

The SME database 690 is formed by subject matter experts, or an automated sub-system created using input from SMEs, based on analysis of the same unstructured verbatim 181 used to derive the customer observables.

While the term SME is used, the personnel reviewing the verbatim for forming the SME database 690, or designing an SME system to do the same, do not have to have a particular level of expertise. The person preferably is well experienced with the product and issues that it may have, such as common vehicle problems regarding automobile applications.

The system is configured in some cases to identify false positive results on only a small, or at least partial, sample of a larger sample, and the SME does the same. The false-positive results, and corresponding machine learning based on these results, improves system operation in identifying critical customer observables on the entirety, or balance, of the sample, as well as on future unstructured text data.

The resulting CO database 190 is populated with what has been identified, according to the processes described above—in various embodiments: as the most relevant, or critical, primary, secondary pairs—e.g., part1, symptom1, part1, symptom2, part2, symptom2, part2, symptom3, etc., along with any of the unique ID of each CO, PMI value of each CO, make, model, model year, and incident date information. The information provides a necessary tool to use in analyzing and, dividing, grouping, etc., the COs related to make/model/model year combination, or the COs that are common to all makes/models/model years, or the COs with high to low PMI values, or the COs by ID count pareto, or the co-occurring COs. This can involve identifying COs extracted from the same ids—e.g., if the Vehicle< >Stall (part< >symptom) is extracted from the IDs say id1, id55, id 153, id634, etc., then extracting related COs from these IDs as the co-occurring CO signature.

The SME database 690 is populated likewise with primary, secondary pairs, identified by the SME, or SME sub-system, based on evaluation of the original verbatim. The SME database 690 and CO database 190 may include different numbers of pairs, such as the SME database including less, or much less.

The SME database 690 pairs are taken as being more accurate, such as by their resulting from individual SME review.

A database (DB) comparison module 610 compares the two databases 190, 690 to identify true positives and false positives amongst the CO database pairs. A false positive (FP) pair is one that does not accurately indicate the subject issue with the part/component. Using the earlier example, if a customer report indicated that the customer is “tired of the horn sounding flat,” a pairing of “tire” or “tired” with “flat” would be a false association, as it does not indicate the real issue of a horn problem, and there is no tire problem.

A feature-identification module 620 identifies features associated with formation of the false positive (FP) pairs. Any helpful features can be identified. Example relevant features include and are not limited to:
1) Position of a primary and a secondary within a sentence:
   a) The position may be indicated, for instance, to the terms' respective start index or end index, in the sentence, for instance.
2) Pointwise Mutual Information (PMI) score:
   a) The PMI score is used as a feature to determine whether to consider a customer observable (i.e. the Part and the Symptom pairing) as a true or a false positive customer observable.
   b) For example, if a customer observable has the PMI score less than zero, then all such COs are marked as the false positives.
3) Number of words between a Primary (part) and a Secondary (symptom):
   a) A specific number of words that appear between a part and a symptom are used as a feature to determine how to remove most of the noisy (false positive) customer observables by retaining the good signature (true positive) customer observables. This is a tunable feature and based on different data sources and depending on the error rate that yields for different data sources the number of words between a part and a symptom is either reduced or increased (automatically by machine).
   b) E.g., over 10 words away for all pairings, or over 10 words for pairings involving certain terms, may be determined to more than likely be a false positive pairing, and so not made, or removed if already made;
4) Number of characters between a Primary (part) and a Secondary (symptom):
   a) In some cases the number of words between a part and a symptom does not provide necessary fine grained granularity to determine whether a specific association of a primary and a secondary is a valid or an invalid association. In such cases, the number of characters that appear between a primary and a secondary are used as a feature to determine how to remove the noisy (false positive) customer observables by retaining the good signature (true positive) customer observables. Again, this is a tunable feature and based on different data sources and depending on the error rate that yields for different data sources the number of characters between a part and a symptom is either reduced or increased (automatically by machine);
5) N^{th} Secondary to Primary:
   a) This feature helps machine to determine how many secondary terms/phrases are considered as valid associations with a primary term/phrase.
   b) E.g., Consider a verbatim “customer states, vehicle was shaking, stalling, and then jerk observed in steering”. In this verbatim, the first two symptoms (secondary), such as ‘shaking’ and ‘stalling’ can be considered as the valid symptoms to be associated with the part, ‘vehicle’.
6) Orientation of Secondary term and/or Primary term:
   a) E.g., whether the primary term is to the left or to the right of the secondary term, whether the secondary is to the left or right of the primary;
7) Pattern(s) associated with the Primary and/or Secondary terms
   a) Patterns noticed around the primary term, patterns noticed around the secondary; alone, together, or either or both with consideration of term position(s).
8) Particular words or symbols, or spacing used in connection with the primary term and/or the secondary term;
9) Applicable linguistics features, such as parts of speech patterns;
10) Sentence structure;
11) Syntax;
12) Misconstrued abbreviations;
13) Misconstrued homonyms
   a) E.g., ON in “engine light ON” versus “engine ON” versus “engine stalled while ON driveway;
14) Levels of granularity
   a) E.g., “vehicle losing power,” being more lay language, versus “car stall” being more technical language, versus use of a specific trouble code—e.g., “Vehicle P2138”);
15) Improper pairings
   a) E.g., it may be false positive whenever or usually when “vehicle” is paired with “replace”, because entire vehicle replacement is rarely at issue, but rather a component of the vehicle being referenced in the unstructured text;
   b) similar regarding pairing of “vehicle” and “illuminated”.
16) Noise in the verbatim affecting pairing, such as any of the above, symbols (&, %, #, etc.), connecting words (e.g., “a,” “an,” “the”), etc.; and
17) Any affecting feature, that affected, improperly, the pair being formed as a customer observable.

In a contemplated embodiment, the feature-identification module 620 can also identify features of true positives (TPs). The TP features can be used to give more weight to future customer observable formation on other unstructured verbatim input. An example type of TP feature is transitivity. Respective spacing between primary and secondary terms (e.g., parts, symptoms, etc.) is identified. A selection of customer observables (COs) can be at one level reduced to a closest group, including only those COs for which the primary and secondary terms of the pair are within a threshold of closeness, such as by being separated by three or more words, and at a higher level reduced to pairs wherein the terms of the pair are directly adjacent or separated by one word. This transitivity analysis is in some embodiments performed after noise has been removed, such as connectors (“the”, “an”, etc.).

III. Select Features, Advantages, Benefits, and Implementations

This section describes some but not all of the features, advantages, benefits, and applications of the present technology, including some of those referenced above.

The approach trains the machine to parse high-volume multi-source data for constructing good quality customer observables quickly and efficiently

Quality customer observables provides an entry point to conduct field emerging issues.

The clustered data using customer observables as data features helps to identify potential hazard severity

The customer observables extracted from different sources can be used sweep an underlying database or databases to determine faults/failures that may be already ‘known’ to an OEM, and faults/failures that are ‘new’ to the OEM. For example, if a safety department computing system, or system and personnel, is analyzing recently collected data from a VOQ or GART source, and would like to determine known and new issues or cases from the data sources when compared with other sources—e.g., GVS_CORE or EI_LOG datasources. The compared-to datasource(s), e.g., GVS_CORE or EI_LOG datasources, can be selected based on a prior determination that the datasource(s) is of top, best, or very high quality, at least comparatively (e.g., known as the gold-standard of datasources). The COs from all these sources can be extracted, and used for comparing fault/failure signatures. In embodiments in which some signatures are semantically similar, the cases that are semantically from one or more databases can be considered ‘known’ and the other cases from the database(s) can be considered ‘new’ cases. For instance, cases exhibiting similar signatures from VOQ or GART databases are considered as ‘known’ cases, while the other VOQ or GART cases are considered as the ‘new’ cases. Given the scale of the data, it is humanly impractical and apparently impossible to conduct such type of analysis in a reasonable, industry applicable, time.

A quality domain ontology promotes construction of higher quality customer observables.

The technology in various embodiments includes a class-based language model that allows us to construct customer observables by associating relevant critical multi-term phrases, e.g. parts, symptoms, accident events, body impact, etc., reported in data without using any pre-defined rule-set or language template.

The customer observables allow linking of multi-source high volume data that helps to identify emerging issues to be detected related to safety and quality

Quality and consistent customer observables provides a valuable insight to identify desired or needed changes to product design or use, or other factors affecting the product.

The technology includes a novel manner to identify and classify customer observable features using the machine-learning algorithm. A machine-learning algorithm identifies features in the text data in various embodiments, and uses the features to classify extracted customer observables and reduce false positives—that is, reduce or eliminate instances in which the system incorrectly associates a subject report about a vehicle (from, e.g., a customer or service report) with a wrong symptom.

As an example, consider a customer report indicating that the customer is “tired of the horn sounding flat.” A less-sophisticated system may identify the word “flat” and automatically assume there is a tire issue, and may associate the report with a pre-established flat tire symptom. Or the system may assume such after noticing the word “flat” and the word “tired,” being close to “tire.” Such association is an example of a false positive association or determination.

Another aspect of the present technology includes a machine-learning algorithm to identify features in text data that allow classification of extracted customer observables, which can be used to reduce false positives. By reducing false positive, the customer observables are even more useable and effective for automated parsing of many—e.g., millions—of unstructured text data points (i.e., unstructured verbatim), as the false positives can be easily identified early and removed or not further read or otherwise processed.

As referenced, the CO data can be used by personnel, computers or automated machinery in various ways, such as to repair a vehicle, communicate an instruction, such as to all dealerships, regarding how to repair a vehicle, to improve a product design, or improve a product-making process, as just a few examples.

The customer-observable output is sent to a destination for analysis and implementation of correction or mitigation activities by an output module, or the output module analyzes and implements the correction or mitigation activities itself, such as diagnosing the problem, and recommending, initiating, and/or making a needed repair.

Robotics may be used to make a needed repair, for instance.

IV. Conclusion

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process. Likewise, modules or sub-modules described or shown separately can be combined for an implementation, and any module or sub-module can be divided into one or more separate modules or sub-modules as desired or determined suitable by a designer or user of the system.

The operations have been presented in the demonstrated order for ease of description and illustration. Operations can be added, omitted and/or performed simultaneously without departing from the scope of the appended claims. It should also be understood that the illustrated processes can be ended at any time.

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A system comprising:
a hardware-based processing unit; and
a non-transitory computer-readable storage device comprising:
an annotation module that, when executed by the hardware-based processing unit:
obtains unstructured verbatim describing a subject product and one or more issues of the product; and
annotates the unstructured verbatim, using a master ontology, yielding annotated output;
a customer-observable construction module that, when executed by the hardware-based processing unit, determines associations amongst terminology in the annotated output, yielding a group of customer-observable pairs;
a customer-observable merging module that, when executed by the hardware-based processing unit, merges at least one first customer-observable pair of the group of customer-observable pairs into at least one second customer-observable pair of the group of customer-observable pairs, or removes the at least one first customer-observable pair, based on similarity between the first and second customer-observable pairs, yielding a group of merged customer-observable pairs;
a pointwise mutual-information module that, when executed by the hardware-based processing unit, determines which customer-observable pairs of the group of merged customer-observable pairs are relatively more-severe or more-relevant, yielding a group of critical customer-observable pairs; and
an output module that, when executed by the hardware-based processing unit:
analyzes the critical customer-observable pairs and implements remediating or mitigating activities based on results of the analysis; and/or
sends the group of critical customer-observable pairs to a destination for analysis and implementation of remediating or mitigating activities.

2. The system of claim 1 wherein the annotation module comprises a preprocessing sub-module that, when executed by the hardware-based processing unit:
removes, from the unstructured verbatim, unwanted characters, spaces, or terms;
lemmatizes terms; and/or
stems terms.

3. The system of claim 1 wherein the annotation module comprises a preprocessing sub-module that pre-processes at least a portion of the unstructured verbatim in a manner based on an identify or characteristic of a data source from which the portion of the unstructured verbatim was received.

4. The system of claim 1 wherein the annotation module comprises an annotation engine that, when executed, in using the ontology, uses an ontology tree or mapping structure.

5. The system of claim 4 wherein:
the tree or mapping structure associates each of numerous common terms or phrases related to the product with one or more classes; and
the classes include any of the following:
defective part;
symptom;
failure mode;
action taken;
accident event;
body impact; and
body anatomy.

6. The system of claim 1 wherein the annotation module comprises an annotation engine that, when executed, uses the ontology and test-structure parsing data to annotate the unstructured verbatim.

7. The system of claim 1 wherein:
each customer observable formed comprises a primary term, and a secondary term; and
the customer-observable-construction module comprises an indices sub-module that, when executed, determines a proximity between the first and secondary terms/phrases.

8. The system of claim 1 wherein the annotation module comprises a verbatim splitter sub-module that, when executed, divides the unstructured verbatim into multiple parts.

9. The system of claim 8 wherein:
each part is a sentence or phrase; and
the customer-observable-construction module, when executed, scans the sentences or phrases to identify key terms or phrases for forming customer observables;
the customer-observable-construction module comprises, for the scanning:
a forward-pass sub-module that, when executed, scans each sentence or phrase in a forward direction; and
a backward-pass sub-module that, when executed, scans each sentence or phrase in an opposite direction.

10. The system of claim 8 wherein the customer-observable-construction module, when executed, based on proximity between a primary term and a secondary term in each of the customer observables, clusters customer observables.

11. The system of claim 1 wherein the non-transitory computer-readable storage device comprises:
a database-comparison module that, when executed by the hardware-based processing unit:
obtains, from a subject-matter-expert (SME) database, SME analysis results about the unstructured verbatim;
compares, in a comparison, the group of critical customer observables to the SME analysis results; and
identifies, based on results of the comparison, false-positive relationships amongst the customer observables of the group of critical customer observables; and
a feature-identification module that, when executed, determines false-positive features related to the false-positive relationships.

12. The system of claim 11 wherein the output module, when executed by the hardware-based processing unit, provides the false-positive features to a machine-learning module for incorporation of the false-positive features into system code for use in subsequent generating critical customer observables.

13. The system of claim 11 wherein the false-positive features comprise, regarding any subject customer observable, at least one feature selected from a group consisting of:
a position of a primary term and a secondary term within a sentence of the unstructured verbatim;
a pointwise-mutual-information score associated with one of the customer observables;
a number of words between a primary term and a secondary term;
a number of characters between the primary term and the secondary term;
a number of secondary terms associated with the primary term;
respective orientation of the secondary term and the primary term in the sentence of the unstructured verbatim;
pattern surrounding use of the primary term and/or the secondary term in the sentence;
particular words, symbols, or spacing used in connection with the primary term and/or the secondary term in the sentence;
a linguistics characteristic associated with the primary term and/or secondary term in the sentence;
a structure of the sentence including the primary term and the secondary term;
a syntax associated with the primary term and/or secondary term in the sentence;
a misconstrued symbol or abbreviation in the sentence;
a misconstrued homonym in the sentence;
a level of granularity in the sentence; and
noise in the sentence.

14. The system of claim 1 wherein:
the non-transitory computer-readable storage device comprises:
a database-comparison module that, when executed by the hardware-based processing unit:
obtains, from a subject-matter-expert (SME) database, SME analysis results about the unstructured verbatim;
compares, in a comparison, the group of critical customer observables to the SME analysis results; and
identifies, based on results of the comparison, true-positive relationships amongst the customer observables of the group of critical customer observables; and
a feature-identification module that, when executed, determines true-positive features related to the true-positive relationships; and
the output module, when executed by the hardware-based processing unit, provides the true-positive features to a machine-learning module for incorporation of the true-positive features into system code for use in subsequent generating critical customer observables.

15. A non-transitory computer-readable storage device comprising:
an annotation module that, when executed by a hardware-based processing unit:
obtains unstructured verbatim describing a subject product and one or more issues for the product; and
annotates the unstructured verbatim, using a master ontology, yielding annotated output;
a customer-observable construction module that, when executed by the hardware-based processing unit, determines associations amongst terminology in the annotated output, yielding a group of customer-observable pairs;
a customer-observable merging module that, when executed by the hardware-based processing unit, merges at least one first customer-observable pair of the group of customer-observable pairs into at least one second customer-observable pair of the group of customer-observable pairs, or removes the at least one first customer-observable pair, based on similarity between the first and second customer-observable pairs, yielding a group of merged customer-observable pairs;
a pointwise mutual-information module that, when executed by the hardware-based processing unit, determines which customer-observable pairs of the group of merged customer-observable pairs are relatively more-severe or more-relevant, yielding a group of critical customer-observable pairs; and
an output module that, when executed by the hardware-based processing unit:
analyzes the critical customer-observable pairs and implements remediating or mitigating activities based on results of the analysis; and/or
sends the group of critical customer-observable pairs to a destination for analysis and implementation of remediating or mitigating activities.

16. The non-transitory computer-readable storage device of claim 15 wherein the annotation module comprises a preprocessing sub-module that pre-processes at least a portion of the unstructured verbatim in a manner based on an identify or characteristic of a data source from which the portion of the unstructured verbatim was received.

17. The non-transitory computer-readable storage device of claim 15 wherein:
each customer observable formed comprises a primary term, and a secondary term; and
the customer-observable-construction module comprises an indices sub-module that, when executed, determines a proximity between the first and secondary terms/phrases.

18. The non-transitory computer-readable storage device of claim 15 wherein:
the annotation module comprises a verbatim splitter sub-module that, when executed, divides the unstructured verbatim into multiple parts.
each part is a sentence or phrase;
the customer-observable-construction module, when executed, scans the sentences or phrases to identify key terms or phrases for determining customer observables, and
the customer-observable-construction module comprises, for the scanning:
a forward-pass sub-module that, when executed, scans each sentence or phrase in a forward direction; and
a backward-pass sub-module that, when executed, scans each sentence or phrase in an opposite direction.

19. The system of claim 1 wherein:
the non-transitory computer-readable storage device comprises:
a database-comparison module that, when executed by the hardware-based processing unit:
obtains, from a subject-matter-expert (SME) database, SME information about the unstructured verbatim;
compares, in a comparison, the group of critical customer observables to the SME information; and
identifies, based on results of the comparison, false-positive relationships amongst the customer observables of the group of critical customer observables; and
a feature-identification module that, when executed, determines false-positive-indicia features related to the false-positive relationships; and
the output module, when executed by the hardware-based processing unit, provides the false-positive-indicia features to a machine-learning module for incorporation of the features into system code for use in subsequently generating critical customer observables better.

20. A process, performed by a computing system having a hardware-based processing unit and a non-transitory computer-readable storage device, the storage device comprising an annotation module, a customer-observable construction module, a customer-observable merging module, a pointwise mutual-information module, and an output module, the process comprising:
obtaining, by an annotation module when executed by the hardware-based processing unit unstructured verbatim describing a subject product and one or more issues for the product;
annotating, by the annotation module, the unstructured verbatim, using a master ontology, yielding annotated output;
determining, by the customer-observable construction module, when executed by the hardware-based processing unit, associations amongst terminology in the annotated output, yielding a group of customer-observable pairs;
merging, by the customer-observable merging module, when executed by the hardware-based processing unit, at least one first customer-observable pair of the group of customer-observable pairs into at least one second customer-observable pair of the group of customer-observable pairs, or removing the at least one first customer-observable pair, based on similarity between the at least one first and second customer-observable pairs, yielding a group of merged customer-observable pairs;
determining, by the pointwise mutual-information module, when executed by the hardware-based processing unit, which customer-observable pairs of the group of merged customer-observable pairs are relatively more-severe or more-relevant, yielding a group of critical customer-observable pairs; and
performing, by the output module, when executed by the hardware-based processing unit, at least one function selected from a group consisting of:
merging the critical customer-observable pairs and implements remediating or mitigating activities based on results of the analysis; and
sending the group of critical customer-observable pairs to a destination for analysis and implementation of remediating or mitigating activities.
